(19) United States
(12) Patent Application Publication
(10) Pub. No.: US 2015/0248532 A1
(43) Pub. Date: Sep. 3, 2015

(54) System and Method for Managing Cognitive Bandwidth to Prevent Failure of Valuable Tasks Requiring Cognition

(71) Applicant: Terry Rajasenan, Pittsburgh, PA (US)

(72) Inventor: Terry Rajasenan, Pittsburgh, PA (US)

(21) Appl. No.: 14/711,672

(22) Filed: May 13, 2015

Related U.S. Application Data
(63) Continuation-in-part of application No. 14/706,960, filed on May 7, 2015.
Application No. 14/706,960 is a continuation-in-part of application No. 13/967,201, filed on Aug. 14, 2013.
Application No. 13/967,201 is a continuation of application No. 13/272,213, filed on Oct. 12, 2011, now Pat. No. 8,515,777.
(60) Provisional application No. 61/993,466, filed on May 15, 2014.
(60) Provisional application No. 61/992,870, filed on May 13, 2014.
(60) Provisional application No. 61/991,014, filed on May 9, 2014.
(60) Provisional application No. 61/990,701, filed on May 8, 2014.
(60) Provisional application No. 61/392,900, filed on Oct. 13, 2010.

(51) Int. Cl. G06F 19/00; G06Q 50/22

(52) U.S. Cl. CPC G06F 19/345; G06F 19/3431; G06Q 50/22

(57) ABSTRACT

Process mining and tipping point analysis is used to determine tasks at risk. Tasks At Risk Intervention lead time analysis determines whether those tasks at risk can be performed in an opportunity window cost-effectively and at a high rate of success by the current task force. Load balancing can be used to offload fungible tasks at risk to flexible resources that can perform those tasks at risk for the highest value opportunities to micro-target tasks at risk with specific countermeasures, perhaps partitioned among several task force members to ensure can be done within the window of opportunity, to ensure their success. The flexible cognitive resources performing fungible tasks can be housed in a hub resource facility to centralize load balancing and obtain scale economies benefits from the shared capacity.

The present application claims the benefit of U.S. Provisional Pat. App. No. 61/993,466, filed May 15, 2014 (pending) and claims the benefit of U.S. Provisional App. No. 61/992,870, filed May 13, 2014 (pending), and is a continuation-in-part of U.S. patent application Ser. No. 14/706,960, filed May 7, 2015 (pending), which claims the benefit of U.S. Provisional Patent App. No. 61/991,014, filed May 9, 2014 (expired) and the benefit of U.S. Provisional Patent App. No. 61/990,701, filed May 8, 2014 (expired), and which is a continuation-in-part U.S. patent application Ser. No. 13/967,201, filed Aug. 14, 2013 (pending), which is a continuation of U.S. patent application Ser. No. 13/272,213, filed Oct. 12, 2011 (patented as U.S. Pat. No. 8,515,777), which claims the benefit of U.S. Provisional App. No. 61/392,900 (expired), all of which is hereby incorporated by reference herein in its entirety.

### BACKGROUND OF THE DISCLOSURE

1. Field of the Disclosure

The present disclosure relates generally to management of healthcare processes, and in particular to identifying tasks at risk for failure based on cognitive loads of healthcare resources derived from knowledge that can be determined from historical data about such resources.

2. Description of the Relevant Art

Process mining can reveal a tremendous amount of information about an organization and its operational processes. For example, process mining can be used to determine, based on a particular starting state, the percentage of time a business experiences certain events or runs into identifiable problems. Oftentimes, these problems can be avoided by performing one or more interventions to reduce or even eliminate the risk of the problem occurring or recurring.

In the healthcare context, for example, among other things, process mining can be used to predict the percentage of time that a patient being admitted to a healthcare facility for a particular problem will be readmitted for the same or a different problem. For example, if a patient being admitted presents certain symptoms, process mining using current and historical data available to the healthcare facility concerning that patient, the symptoms that patient is presenting, and historical data related to other patients may indicate there is a 25% chance that the patient will be readmitted for congestive heart failure (CHF).

By performing the interventions, readmissions for the predicted problem are often avoidable. For example, in the case of the patient predicted to be readmitted for CHF, performing an intervention may prevent such readmission. Interventions can take a number of forms, including, for example, automatic follow up to ensure that a discharged patient is following proper medicinal, dietary and exercise protocols.

Oftentimes, healthcare providers pursue interactions according to a checklist of tasks to perform. In the vast majority of cases, however, the healthcare provider proceeds without any consideration of the amount of time that the tasks will take to complete. Thus, the healthcare provider has little if any knowledge about whether the tasks can be completed in a required amount of time. Starting the intervention process when there is insufficient time to complete it is wasteful of both healthcare provider time, as well as money spent to begin the ultimately futile intervention.

Another problem with the checklists is that is that requiring healthcare providers to perform every item on a checklist can lead to that healthcare provider reaching a tipping point, that is, a point where the likelihood that they will not complete a checklist task or not complete a checklist task adequately rises sharply. As a result, such tipping points should be avoided to the extent possible.

### SUMMARY OF THE VARIOUS EMBODIMENTS

In an embodiment, a method to improve efficiency in an organization comprises determining one or more tasks that must be performed to properly treat a patient, identifying at least one task at risk from the one or more tasks, and performing load balancing to offload the task at risk to a fungible resource that can perform the task at risk.

Embodiments look at retrospective and concurrent data to derive an overall opportunity score to identify those tasks at risk that will promote efficiency in an organization. Tasks at risks are high value tasks that are at risk of not being performed, or not being performed adequately. The identified tasks at risk are allocated among available healthcare providers to avoid tipping points, that is, the point at which, due to cognitive overload, healthcare provider effectiveness and/or efficiency begins to drop off sharply (i.e. people make mistakes and slow down).

In an embodiment, the retrospective data determines the diagnoses for patients being treated in a healthcare facility, and from those diagnoses the tasks that must be completed to treat the patients as well as the mortality rate associated with the diagnoses for the patients being treated. Retrospective analysis also identifies (when there are data elements that help identify the caregiver or team member involved, like the Nursing Unit, Nurse author of notes, Attending Physician assigned, etc.) those tasks that healthcare providers in the healthcare facility have failed to perform or failed to perform adequately in the past, and the causes of such failure. Past failures are likely indicators of future failures in the same or similar conditions. Concurrent data analysis determines average task value for a current patient being treated, current cognitive load on the frontline healthcare providers that are responsible for treating patients, the cognitive load on support healthcare providers to which tasks at risk can be offloaded, and the cognitive load required by the current patient being treated. Using this information a task at risk (“TAR”) opportunity score is derived. In an embodiment, if the task at risk opportunity score exceeds a threshold, those tasks are allocated among the healthcare providers to be completed.

In an embodiment, a method for managing cognitive bandwidth in a healthcare organization, including determining a diagnosis for a patient based on one or more symptoms presented by the patient, determining one or more tasks to perform to treat the patient based on the determined diagnosis, determining a cognitive capacity of a healthcare provider team that is responsible for caring for the patient, determining tasks at risk for treating the patient, determining a task at risk opportunity score for treating the patient, and allocating the tasks at risk to avoid reaching a tipping point of any healthcare provider in the healthcare provider team.

In another embodiment, determining the task at risk opportunity score includes determining a cognitive load needed score, determining a cognitive load of the healthcare provider team score, determining a cognitive load of a flexible resource team score, determining an average task value for the tasks at risk, and summing the determined cognitive load needed score, the cognitive load of the healthcare provider team score, the cognitive load of the fungible resources team score, and the average task at risk value to calculate the task at risk opportunity score.

In another embodiment, determining a task at risk includes identifying high value tasks from the one or more tasks to perform to treat the patient, identifying tasks that are at risk of failure from the one or more tasks to perform to treat the patient, and determining as tasks at risk those tasks identified both as high value and as at risk of failure.

In another embodiment, a system for managing cognitive bandwidth in a healthcare organization includes a healthcare demand module to determine a diagnosis for a patient based on one or more symptoms presented by the patient and one or more tasks to perform to treat the patient based on the determined diagnosis, a tipping point module to determine a cognitive capacity of a healthcare provider team that is responsible for caring for the patient, a performance improvement coordinator (PIC) module to determine tasks at risk for treating the patient and a task at risk opportunity score for treating the patient, and to determine a task at risk allocating to allocate tasks at risk to avoid reaching a tipping point of any healthcare provider in the healthcare provider team, and a notification module to notify one or more healthcare providers of tasks at risk they are to perform.

In another embodiment, the PIC module further determines a cognitive load needed score, determines a cognitive load of the healthcare provider team score, determines a cognitive load of a flexible resource team score, determines an average task value for the tasks at risk, and sums the determined cognitive load needed score, the cognitive load of the healthcare provider team score, the cognitive load of the fungible resources team score, and the average task at risk value to calculate the task at risk opportunity score.

In another embodiment, the PIC module further identifies high value tasks from the one or more tasks to perform to treat the patient, identifies tasks that are at risk of failure from the one or more tasks to perform to treat the patient, and determines as tasks at risk those tasks identified both as high value and as at risk of failure.

The ultimate goal of embodiments is to enable micro-targeting on tasks at risk to apply an earlier/proactive intervention of an IHBP proven TAR countermeasure (notified via work lists or managed alerts) to prevent a preventable problem that is at risk of occurring with a high expected value of return on investment.

### BRIEF DESCRIPTION OF THE DRAWINGS

FIG. 1A illustrates an exemplary storage structure for a healthcare provider related to that healthcare provider's cognitive bandwidth, according to an embodiment.

FIG. 1B illustrates an exemplary performance versus cognitive bandwidth curve for a healthcare provider, according to an embodiment.

FIG. 2A illustrates an exemplary healthcare demand and healthcare supply (cognitive bandwidth) versus time without task load balancing, according to an embodiment.

FIG. 2B illustrates and exemplary healthcare demand and healthcare supply (cognitive bandwidth) versus time with task load balancing, according to an embodiment.

FIG. 3 is a flow chart for a method for managing cognitive bandwidth to prevent failure of valuable tasks requiring cognition according to an embodiment, according to an embodiment.

FIG. 4A illustrates an patient exemplary scoring model for scoring symptoms presented by a patient to determine healthcare demand and identify tasks that must be completed for patients, according to an embodiment.

FIG. 4B is a graph of information stored in an exemplary patient scoring model, according to an embodiment.

FIG. 5 is a flow chart for performing the retrospective operation for determining a tasks at risk opportunity score according to an embodiment.

FIG. 6A is a flow chart for performing the concurrent operation for determining task at risk opportunity score according to an embodiment.

FIG. 6B is an exemplary TAR scoring model according to an embodiment.

FIG. 6C is a graph of the information contained in TAR scoring model.

FIG. 6D is a flow chart for determining tasks at risk according to an embodiment.

FIG. 6E is a Venn diagram that illustrates that tasks at risk are those tasks at the intersection of high value tasks and tasks at risk of failure.

FIG. 7 illustrates an embodiment showing interconnectivity between healthcare facilities in a healthcare system to allow distributed fungible resources for offloading tasks at risk, according to an embodiment.

FIG. 8 illustrates another structure for a healthcare system according to an embodiment showing interconnectivity between healthcare facilities in a healthcare system to allow distributed fungible resources for offloading tasks at risk, according to an embodiment.

FIG. 9 illustrates structure for another embodiment showing a hub of flexible resources that can service healthcare facilities in a healthcare system, according to an embodiment.

FIG. 10 illustrates structure for another embodiment showing a hub of flexible resources that can service healthcare facilities in a healthcare system, according to an embodiment.

FIG. 11 is a block diagram of an example computer that may be used to implement the apparatus and methods described herein according to an embodiment of the present invention, according to an embodiment.

FIGS. 12A-12C illustrate an example of process redesign using cognitive modeling, according to an embodiment.

FIG. 13 is a graph that illustrates the effects of a hospital stay on patients and the physiologic changes they can go through that affect their ability to learn and absorb information.

FIG. 14 illustrates a system for managing cognitive bandwidth by allocating tasks according to an embodiment.

FIG. 15 illustrates a healthcare continuum.

The figures depict certain embodiments of the present disclosure for purposes of illustration only. One skilled in the art will readily recognize from the following description that alternative embodiments of the structures and methods illustrated herein may be employed without departing from the principles of the various embodiments of this disclosure.

### DETAILED DESCRIPTION OF THE VARIOUS EMBODIMENTS

Embodiments of the present invention identify tasks at risk (TAR) and then schedule those tasks at risk for performance to avoid tipping points. The term “task at risk” (“TAR”) has a number of meanings including a task that may not be performed sufficiently or at all in a given situation and a high value task that is at risk of not being performed sufficiently or at all. Unless the context of the use indicates otherwise, as used herein, the term “task at risk” means a high value task that is at risk of not being performed sufficiently or at all. High value means those tasks that have a highest expected value of return on investment (“EVoROI”). Thus, high value is not necessarily the most important task. For example, an important task that cannot be performed in a given time window is not considered a high value task because it cannot be performed. Such a task is considered a low value task despite its importance.

Failure to perform tasks at risk leads directly to reduced efficiency for healthcare providers and increased costs for healthcare facilities. Cognitive overload, that is, inadequate cognitive bandwidth to perform required tasks, yields a probability that those tasks will not be performed adequately to obtain the expected value from them. Failure to perform a particular task thus leads to a probability that certain negative outcomes will occur. These outcomes range from inefficient use of resources to patient mortality. Each of these outcomes has a cost associated with it. Summing the products of the costs and probability of each of the outcomes for failure to perform each of the tasks at risk leads to an overall excess costs that is, costs that could have been avoided if the tasks at risk were performed.

Importantly, and especially prevalent in healthcare settings, is that “safer” (more conservative) decisions tend to cost more. For example, readmitting a patient is a “safer” decision than discharging a patient. Discharge costs a healthcare facility virtually nothing, whereas readmission costs can vary greatly, up to $20,000 per patient readmission in some cases. Avoiding intensive care units (ICUs) can save upwards of $700/day versus staying on the floor. However, because there are more resources at the healthcare facility or in ICUs, these are safer decisions for provisioning healthcare versus discharge or not sending a patient to an ICU. This issue becomes important in a tipping point analysis because healthcare providers who are overloaded, that is, who have, or have nearly, reached their cognitive bandwidth, generally are unable to fully analyze or treat a particular patient. Thus, they generally take the safest approach, which is almost always to do more than required, such as admit the patient, or send the patient to an ICU, when such action is most likely unnecessary according to evidence based medicine. Had the healthcare provider not been overloaded, he or she would have been able to more fully analyze the situation (i.e. “connect the dots”) and order a more specific treatment rather than order a too wide array of tests, or determined admission was unnecessary. Accordingly, identifying and preventing overload leads directly to increased efficiency and reduced costs for a healthcare facility.

In embodiments, the interventions to be performed are the tasks required to successfully treat a patient. These interventions require time to complete. The time required to perform an intervention defines a “window of opportunity” during which to perform the intervention. An intervention that cannot be performed in the time remaining prior to discharge of the patient is said to not fit within the window of opportunity.

In embodiments, not all tasks for treating a patient will necessarily be performed. Only those tasks at risk are required to be performed. Other tasks are either already performed, likely to be performed, or are not required to be performed in particular instances.

According to an embodiment, intervention lead time analysis (“ILTA”) is used to determine whether interventions can be performed in a given time window, referred to herein as the “opportunity window.” Intervention lead time analysis relies on predictive modeling to probabilistically determine the intervention that a particular patient needs and to take measures to assure that the intervention can be performed within the opportunity window. As such, intervention analysis can lead to a higher likelihood of successful patient outcomes.

However, using predictive models to determine when interventions are required has a certain degree of uncertainty. That degree of uncertainty decreases as prediction accuracy increases. For example, if the prediction accuracy is 25%, there is a 75% chance the prediction is wrong. That is, 3 out of every 4 predictions is wrong. Because they are wrong, these errant interventions are unnecessary. These unnecessary interventions can be translated into wasted man hours. For example, if 2 man-minutes were needed to evaluate a case upon admission to a healthcare facility, then on average 6 man-minutes would be wasted on unnecessary interventions. If 10 patients are admitted each day, 60 man-minutes would be lost to unnecessary evaluation. Thus, the problem scales as more patients are admitted. An analogy would be the proverbial “finding a needle in a haystack”—TAR-ILTA helps determine how much “hay” we have to go through to find 1 needle in each scenario. For example, if 100 patients are admitted, 10 man-hours (600 man-minutes) would be lost to unnecessary interventions.

In some cases additional information may be available that improves prediction accuracy. For example, in the case of a healthcare facility a patient may have additional evaluations or testing that can improve prediction accuracy. For example, additional diagnoses may provide additional information. Where readmissions are concerned, additional evaluation in healthcare facility triage may suggest the patient is likely to be a CHF readmission patient. The additional information gained, for example, by this additional evaluation, may raise the prediction accuracy of CHF readmission, for example, to 50%. That is, with the additional information, the error rate is reduced to 1 out of 2 predictions is wrong. Thus, 1 out of 2 interventions is unnecessary. As a result, in the example, above, man hours wasted on interventions is reduced from 6 man minutes to 2 man minutes on average. If the lead time intervention analysis provides a 75% prediction accuracy, man hours wasted on unnecessary interventions is reduced to 30 seconds. The 30 seconds of wasted man hours associated with a 75% prediction accuracy can represent a 90% reduction from the 6 minutes of wasted man hours associated with a 25% prediction accuracy.

Like interventions, the steps necessary to get the information for a desired prediction accuracy require time to complete and the time for their completion must be considered to determine whether treatment can be performed in the opportunity window.

In an embodiment, the length of the window of opportunity is determined based on the symptoms presented by a patient when they enter the healthcare facility. At that time, an initial diagnosis is made by a healthcare provider or predicted based on the symptoms presented by the patient. The diagnosis is compared to a database of diagnoses and corresponding average mean length of stays (“AMLOS”). The AMLOS corresponding to the predicted diagnosis is used as the opportunity window. In an embodiment, the AMLOS value for a particular diagnosis is determined using historical hospital records, especially the electronic information that is becoming ubiquitous in healthcare. For example, in an embodiment, AMLOS values are determined using data captured by a healthcare facility's electronic medical records (EMR) or electronic health records (EHR) systems.

As a result of the limited window of opportunity, some interventions may be wasteful because there is no point in starting an intervention if there is insufficient time to complete it. Thus, while additional evaluation or testing may improve prediction accuracy for a particular intervention, the particular intervention may not be possible because the time required for the additional evaluation or testing leaves insufficient time perform the required intervention. Such wasteful interventions can lead to adverse results because resources are wasted performing essentially useless tasks that could be better devoted to performing tasks that are more likely to lead to a successful result. In the case of a healthcare facility for example, devoting resources to interventions that cannot be completed means those resources cannot be allocated to tasks for saving another patient.

One answer to this problem is to devote additional resources to performing the intervention to reduce the amount of time required for the intervention. For example, assigning an additional person to a particular intervention may reduce the time required to perform the intervention by half. But, this depends on being able to partition the work for a particular intervention. Where partitioning is not available or does not allow the intervention to fit within the window of opportunity, triage of the work may be required, that is, deciding which patients can be most helped by assignment of resources. This can also be viewed as reprioritizing tasks.

Rather than view interventions from a patient perspective, that is identifying patients with the most issues, embodiments of the present invention look at tasks at risk and allocation of those tasks at risk to avoid cognitive overload of healthcare providers and, in some cases, patients. Tasks at risk are high value tasks that are required for a successful result, but for some reason, such as lack of time, lack of expertise, or for some other reason, may not get performed or may not get performed sufficiently. Thus, embodiments of the present invention consider interventions on a task-by-task basis rather than a patient-by-patient basis. As a result, embodiments maximize the probability that tasks at risk are accomplished within the window of opportunity. Once the high value tasks that are at risk of failure are identified such as through the patient at risk diagnoses (e.g. CHF has 5 key tasks that evidence based medicine core measures require doing), then the countermeasure that is proven to work (and thus makes the task at risk that much more valuable) can be applied by a team qualified to perform that countermeasures set of tasks—as long as they will not themselves overload and fail at the countermeasure, which would render the countermeasure useless and thus low value.

In embodiments, process mining is used to determine the effect of cognitive overload on tasks that need to be accomplished. For example, in the case of CHF readmission, it may be that cognitive overload results in healthcare providers not performing certain checklist tasks at risk adequately or at all, or patients not performing tasks required to prevent readmission. For example, healthcare providers experiencing cognitive overload may forget to perform certain checklist tasks or may not instruct patients well on taking their medications, if at all. Patients experiencing cognitive overload may not learn how to take their medications well. A consequence of failures such as patients not following post-discharge instructions is an increased likelihood of readmission. As a result, healthcare provider and/or patient cognitive overload is likely to lead to readmission and increased costs.

Changing the focus from patients-at-risk to tasks at risk allows for large improvements in efficiency. For example, if a particular patient intervention requires 10 tasks of double-checking/quality assurance, a patient-centric perspective requires all 10 tasks be performed. However, if only 1 task is at risk, a 90% improvement is achieved simply by focusing resources only on the 1 task at risk. Typically, since there are false positives in most modeling, the number may be 2 or 3 tasks that need checked, but it is still around a 75% time savings, or a “force multiplier” of 4 times. That means the team can be just one-quarter the size (and cost) of a team that did not focus on just tasks-at-risk.

In an embodiment, tasks at risk are identified using a tipping point analysis. A tipping point analysis determines when resources required to perform a particular task are cognitively overloaded to the point that a certain task or set of tasks is at risk of not being completed. Different persons may have different tasks that they drop when they reach cognitive overload, that is, reach a tipping point. Not only may tipping points be different for different people, but the tasks they are likely to drop may be different for different persons. Thus, embodiments seek to reallocate tasks at risk to avoid any member of a healthcare provider team experiencing cognitive overload.

In an embodiment, resource tipping points are determined using data mining to determine resource supply versus resource demand. For example, for a particular problem requiring resources in an organization, the demand and supply for those resources is predicted. For example, historical data may be reviewed to determine, for each healthcare provider, those tasks the healthcare provider is likely to drop, and the conditions under which he or she is likely to drop tasks. For example, retrospective data analysis may suggest a certain healthcare provider drops a particular task often when he or she has to treat 2 or more patients concurrently. Thus, the healthcare providers tipping point for that task is 2 patients. Note that cognitive overload is more likely when there are 2 very complex (and thus high cognitive load patients) than when it is 2 simple patients that will take little time and intellectual effort. Patient at risk identification can help distinguish between these 2 scenarios.

Alternatively, the current state of a healthcare facility is determined to know which providers are performing which tasks at the time a tipping point determination is made. In an embodiment, demand for resources is determined by looking at the tasks required to respond to the problem and the resources required to perform those tasks. In an embodiment, supply for resources is determined by considering those resources an organization has to respond to the determined demand for resources using the current countermeasures that currently can prevent certain problems. Improvements in processes by avoiding tipping points impacts the effectiveness of task execution, reduces task failures, and thereby reduces failure of tasks at risk.

Further, embodiments consider healthcare provider team activation. Healthcare provider team activation occurs when a particular healthcare provider has reached a tipping point and requires intervention to avoid failing to perform tasks at risk. Process mining on incoming data using TAR-ILTA to determine opportunity ensures the highest value for teams activated (and interrupted, as interruptions contribute to cognitive overload as well) and the time they will spend on the intervention. In an embodiment, this is determined by the number and type of tasks that the particular healthcare provider is performing. When the healthcare provider reaches a tipping point, additional members of the healthcare team can be activated to perform a countermeasure to avoid the tipping point. Such countermeasures include double checking tasks and quality assurance, offloading the task-at-risk to another team members (that could also be at another place, using telecommunications or tele-health), offloading tasks other than the task-at-risk to other team members (to get team member below their tipping point), performing the task at a later time. Activation of teams is the key—how many tasks must be done by someone before they can and should activate a team to initiate a countermeasure. Then once activated, the key question the scoring model must address is how many tasks must be done in order to complete the countermeasure and thus be effective in the prevention. Devices that can identify the location of a person, such as smart phones, tracking tools, etc., help in knowing exactly where a person is can drive their TAR—if they are further from the patient, then that could mean being rushed (so overload, anxiety, etc.) and/or that they do not have time to complete an intervention. Thus, this could be added to the TAR-ILTA scoring model.

Determining tipping points uses an individual's cognitive capacity. Cognitive capacity is the cognitive limit for individuals and business entities. Cognitive load is the amount of cognitive capacity being consumed by a particular task demand or load level. Cognitive bandwidth is the difference between cognitive capacity and cognitive load. That is, cognitive bandwidth is what remains after cognitive load is applied to cognitive capacity. A cognitive overload occurs when cognitive bandwidth falls to zero or below zero (i.e. no more available capacity to being asked to do tasks beyond the historical tipping point derived for capacity limits before tasks are disproportionately dropped). In the healthcare context, the cognitive capacity of both the healthcare providers and patients is considered. That is, patients are considered to contribute as healthcare providers for their own care.

When cognitive capacity is considered, simply providing more training may not be sufficient to avoid cognitive overloads. That is, training itself may not solve cognitive overloads. In fact, training may contribute to cognitive overloads where an individual becomes overwhelmed such that he or she is not capable of absorbing additional information. For example, in the healthcare context, simply providing additional training to healthcare providers may not allow them to perform better where they are already stretched too thin. Forcing the healthcare providers to pursue additional training may leave them insufficient time to do other required tasks. This in turn leads to stress and distraction and, as a result, a higher likelihood of task failure, whether tasks are not performed at all, or tasks are not performed adequately. Similarly, patients may be incapable of absorbing all information related to their care for a number of reasons including, pain, medication, and stress. Thus, time and money can be saved by avoiding training where it will exacerbate cognitive overload.

In an embodiment, tipping point analysis is used to determine which tasks a particular person, such as a healthcare provider, has problems completing as their cognitive load increases. In an embodiment, this is done by process mining historical data of an entity to determine the cognitive load when each individual in the entity begins to experience task failure. For example, in the healthcare context, a particular diagnosis may required 5 tasks be done by a particular doctor. However, process mining and data analysis shows that the particular doctor has problems completing one of the 5 tasks when his cognitive load exceeds a certain percentage. For example, for a patient presenting a CHF case, the doctor may have difficulty completing task 3 of a checklist for CHF treatment when his or her cognitive load exceeds 75%, or a certain number of concurrent tasks.

Further, where there is not sufficient data for determining tipping points of a healthcare provider in a healthcare facility, an average can be determined where other healthcare providers in the healthcare facility reach tipping points can be used as a start. If there is insufficient data within a single healthcare facility, data corresponding to the tipping points of healthcare providers in other healthcare facilities can be used as an initial tipping point. The data for the healthcare provider can be updated as required to more accurately reflect the tipping point for the healthcare provider to which it corresponds as more data is collected for that particular healthcare provider's tipping points.

For example, in an embodiment, process mining is performed by looking at event logs to determine what was done based on available data, the time it was estimated to be done or actually done, and finally inferring the tasks. Task inference can be by order set, when the diagnosis uses a single order set, or based on in-house best practices (“IHBP”), where more complex diagnoses are concerned. An exemplary such order set analysis is described in the Veluswamy, Ragupathy, “Golden Nuggets: Clinical Quality Data Mining in Acute Care,” Journal of the Physician Executive (May-June 2008), which is hereby incorporated by reference herein in its entirety.

In another embodiment, process mining analyzes unstructured text to provide a task list of what's been done in the past and what is requested to be done in the future. In addition, unstructured text analysis provides a safe discharge checklist, so that, for example, an emergency department (“ED”) doctor can explain why he or she was able to discharge a patient safely or why he or she decided to admit the patient. For example, the unstructured text may say a family has asked a lot of questions. This is an indication of a large cognitive capacity drain on healthcare resources who must devote time to respond to the family's inquiries. Process mining can look to other sources of data that might provide information related to healthcare demand and supply to meet that demand.

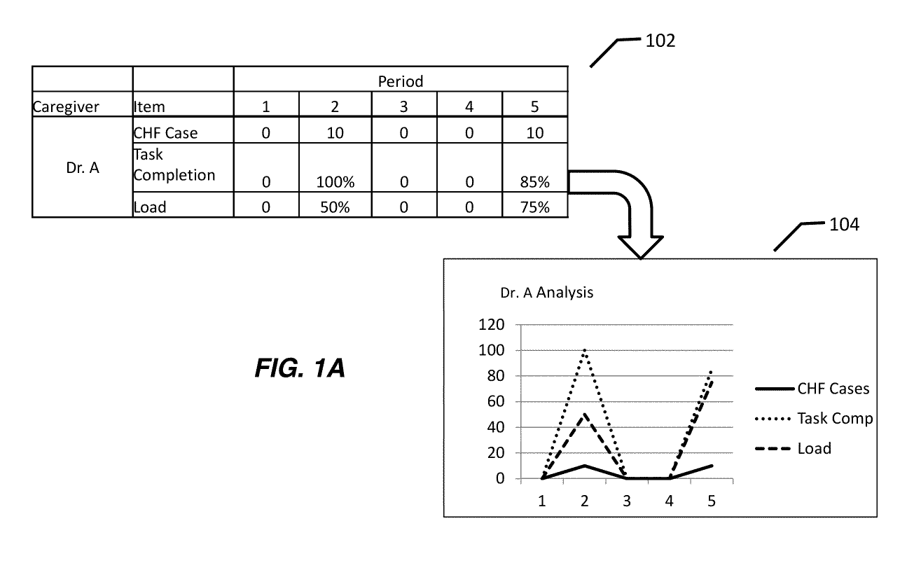

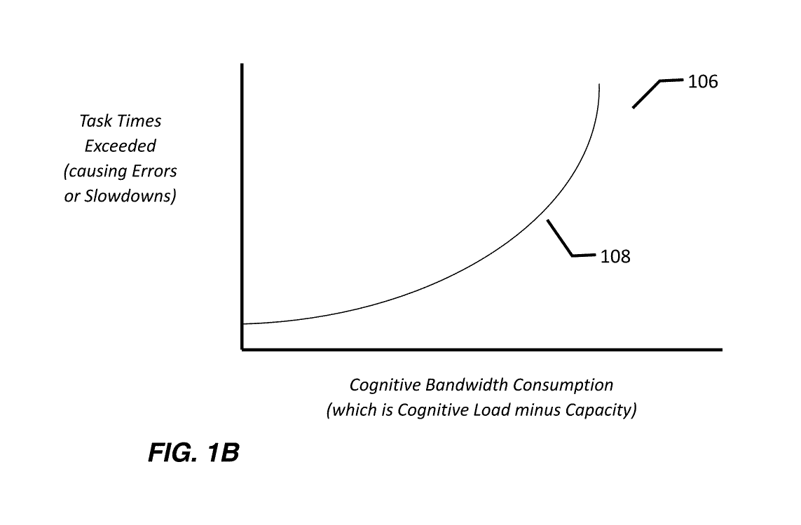

FIG. 1A illustrates a storage structure 102 for storing the results of process mining to determine tipping points for an exemplary Dr. A. Graph 104 graphically presents the information in storage structure 104. Storage structure 102 stores the number of tasks for each item (case type that can be handled by a healthcare provider), the completion rate for those tasks, and the load at which the completion rate is achieved. As can be seen in FIG. 1A, process mining revealed that Dr. A that for CHF cases, Dr. A is able to complete all 10 tasks required for a CHF case when her cognitive load is 50% or less of her cognitive capacity. Thus, Dr. A can complete 100% of the tasks associated with a CHF case so long as her cognitive bandwidth is 50% or greater. However, Dr. A's efficiency drops to 85% when her cognitive load increases to 75% of her cognitive capacity, or put another way, her cognitive bandwidth is reduced to 25%. Using process mining and data analysis, similar analyses can be performed for all healthcare providers in a healthcare facility and a storage structure 102 can be created for each such healthcare provider.

As resources are assigned to a healthcare provider to perform particular tasks, their cognitive bandwidth is reduced and stored as described above with respect to FIG. 1A. That is, if Dr. A is assigned another task, Dr. A's available bandwidth is reduced to account for that additional assignment, and stored. In that way, an assessment of Dr. A's tipping point can be made to (1) identify tasks at risk where Dr. A is responsible for performing those tasks, (2) determine whether Dr. A can be assigned additional tasks, and (3) determine the complexity of tasks that can be assigned to Dr. A. Different data can be stored in particular embodiments dependent on the needs of that particular embodiment.

FIG. 1B illustrates an exemplary performance versus cognitive bandwidth curve 106 that can be created from process mining healthcare provider performance. As shown in curve 106 once a tipping point 108 is reached, task errors increase disproportionately as cognitive consumption increases because cognitive consumption reduces the healthcare provider's cognitive bandwidth. In an embodiment, the tipping point information from curves such as curve 106 is used to provide the information in storage structure 102. Using the information in storage structure 102 for each healthcare provider in a healthcare facility, a task at risk can be reallocated to prevent tipping points. Or other tasks can be offloaded to reduce the tasks at risk of the team member that has exceeded their tipping point. Additional details for tipping point analysis can be found in U.S. Pat. No. 8,515,777, filed Oct. 12, 2011, which is hereby incorporated by reference in its entirety.

Task at risk analysis provides insight into what changes to make to processes to improve efficiency. In particular, unnecessary steps or tasks can be identified and eliminated. Reducing and eliminating unnecessary steps or tasks also reduces interruptions, and streamlines evaluative tasks. In addition, flexible resources can be identified to partition work differently and use more specialization. Comparative advantage can be applied to divide workload, which allows individuals to provide more focus, for example, by using more abundant low cost resources. Comparative advantage refers to the concept that a first actor can provide a product or service at a lower opportunity cost than a second actor, even where the second actor is better at providing the product or service than the first actor. Identifying tasks at risk provides insight into tipping points for key personnel, identifying those tasks that can be dropped, and improves task completion and problem solving using more efficient, proactive distribution of cognitive capacity throughout a business enterprise, such as a healthcare facility.

Task at risk analysis also allows more insight into adding additional resources, such as manpower. For example, is a task better serviced (i.e., has a higher likelihood of being complete adequately) by adding more direct care personnel or more support personnel, and in what quantity, as well as whether to move current personnel to new responsibilities through, for example, cross-training or new training Task at risk analysis also allows intelligent choices to be made concerning situation-based education. For example, such analysis can be used to determine if task execution will benefit most from practice-based education (e.g., hands on or on the job training) or non-practice-based education (e.g., classroom or one-on-one training).

According to an embodiment, interventions are performed using (1) data availability timing and (2) task demand timing. Data availability timing considers when sufficient data is available to determine required interventions. Required interventions, in turn provides required tasks, from which, using tipping point analysis, tasks at risk are determined. Task demand timing considers the opportunity window for performing tasks at risk required by a particular intervention, and allocating resources to ensure those tasks at risk can be performed within the opportunity window.

In an embodiment, when a patient enters a healthcare facility, a set of tasks for treating the patient is determined based on the particular set of symptoms presented by the patient. In an embodiment, for example, the tasks required for treating the patient are determined by comparing the symptoms presented by the patient to a database containing tasks that are required to be performed according to in-house best practices to treat a patient with the symptoms presented.

A “widow of opportunity” determination is made for the expected length of time it will take to complete the identified tasks to treat the patient. In an embodiment, this window of opportunity is defined in terms of a start time for beginning the task and a deadline for completing the identified tasks. Deadlines can be in terms of absolute times of day (e.g., 8:24 am) or relative time periods during which to complete a task (e.g., 6 hours). Start times are the time when a healthcare provider is given report or alert to respond to. Deadlines are dependent on the particular task. Some deadlines are mandates, for example, by in house best practices. For example, the deadline might be 48 hours when the patient is present on admitted. For core measures, such as giving antibiotics, the deadline might be 6 hours. Other deadlines are determined from historical analysis of the times to perform certain tasks. For example, historical analysis might show that ED physician admit or discharge patients within 4 hours on average. Thus, the deadline for an emergency department physical taking a required action is 4 hours. It is possible that a report or alert could be provided at or after the deadline. In such a case, there is a zero or negative lead time, and the identified task cannot be performed within the opportunity window. Thus, a positive lead time is required for tasks at risk to be assigned to be performed in embodiments. The higher the lead time, the greater the opportunity to take countermeasures to avoid healthcare providers reaching tipping points.

Healthcare facility resources are identified to perform the tasks. Available capacity bandwidth of the assigned healthcare facility resources is determined. Using the determined capacity bandwidths, a tipping point analysis is performed to determine which of the required tasks are tasks at risk, that is, high value tasks that because of limited capacity bandwidth are in danger of being performed poorly, if at all. Thus, tipping point analysis helps ensure that assigning resources to perform particular tasks will not negatively affect efficiency in providing healthcare to the patient. If the tipping point analysis indicates that tipping point are being reached, one of the following interventions is performed (i) double checking the tasks (ii) assigning the tasks to different healthcare provider(s), (iii) offloading other tasks to increase the cognitive bandwidth of the healthcare provider, (iv) delaying task performance, (v) or taking some other countermeasure to reduce the cognitive load of the healthcare provider. Where the opportunity window is exceeded by the required tasks, ways of shortening the time required to complete the tasks are explored. For example, in an embodiment, tasks that might otherwise be performed by one person are partitioned, to the extent possible, among two or more “flexible” resources that can complete the tasks. Flexible resources are also referred to herein as support resources or fungible resources.

Because intervention lead time analysis identifies tasks at risk at the earliest time, it allows focus (via preventive countermeasure to avoid the task at risk failure) at a time when they are most likely to be able to be accomplished within the opportunity window. Put another way, healthcare providers no longer need to perform every required task at the time a patient is admitted to increase the probability of a beneficial outcome. Instead they need to only perform those high value tasks that are at risk of not being performed within the opportunity window. Intervention lead time analysis based on process mining and tipping point analysis gives a healthcare provider the best chance of providing positive results for the patients in view of limited resources and limited opportunity windows during which to perform tasks at risk.

Decreasing the number of tasks that need to be performed at any particular time also increases the likelihood that the tasks will be carried out correctly and facilitates communication of those tasks. For example, consider the case where the tasks involved are 10 tasks that must be communicated to a patient to care for themselves, but only 3 of those tasks are at risk of not being performed because the patient effectively performs the other 7. By communicating only the 3 tasks at risk to the patient, but not the other 7 tasks, there is higher likelihood that those 3 tasks will in fact be communicated to the patient, versus having to communicate all 10 tasks. Further, there is a higher likelihood the patient will remember the 3 tasks at risk, and therefore perform them (along with the 7 other tasks the patient already performs successfully), than if all 10 tasks are communicated to the patient.

Using process mining and tipping point analysis to identify tasks at risk and allocating the tasks at risk to avoid cognitive overload lowers task at risk failures. For example, if there are 10 patients, each having 10 checklists, with 10 tasks, there are 1000 tasks to perform. Assume there are 5 providers, who can handle 5 of the checklists, and 5 of the tasks thereon. Those 5 providers can therefore perform only 125 of the tasks. Thus, the task demand overload exceeds the task fulfillment supply. But, assume that intervention lead time analysis described above using process mining and tipping point analysis identifies there are only 2 tasks at risk on 2 checklists for 2 patients that need to be performed within an opportunity window, that is, there are only 8 tasks at risk that must be performed by the available supply. That is of the 1000 tasks, only 8 are tasks at risk. Now, because only 8 tasks need to be performed, the 5 healthcare providers are more than capable of performing those tasks. The other 992 tasks will be performed typically already by the healthcare provider, by other resources in the healthcare facility, or, based on risk analysis, have a low enough expected value that they should not be undertaken (or could be done if there is no other work). Another advantage of lead time analysis in this case is that it provided excess cognitive capacity for the healthcare providers so they can perform other tasks.

However, this expected value determination is often not done when, due to cognitive overload, the team or a key member of it is unable to do the thinking necessary to calculate the Expected Value of Return on Investment (EVoROI) of the task and can't weigh the decision properly. As a result, healthcare providers that are at or near their tipping points will likely choose to provide services not based on any analysis of what the patient needs, but what is the healthcare provider believes is safest, even though it is likely to be far too extensive, which will end up costing more and introduce safety risks to the patient. In short, healthcare providers at or near tipping points tend to perform more tasks on a given patient than are necessary to safely treat the patient.

Process arbitrage is about finding those few tasks that have disproportionately large costs associated with them if they are not performed. For example, once a tipping point or inflection point in the cognitive load vs. performance error rate is found, then adding a task near that inflection point can create a “jump” in errors, and conversely, removing 1 task that takes a person below that inflection point yields a non-linear, significant drop in error rate. In short, 1 task moved near the tipping point can mean more impact than 2 tasks moved far away from the inflection point. Once those tasks are identified, cognitive load balancing is used to allocate resources so that those tasks get done. In an embodiment, process arbitrage is performed by analyzing available healthcare supply and healthcare demand to exchange the minimum number of tasks to achieve a higher likelihood and higher degree of successful patient outcomes, including quality, safety, and cost.

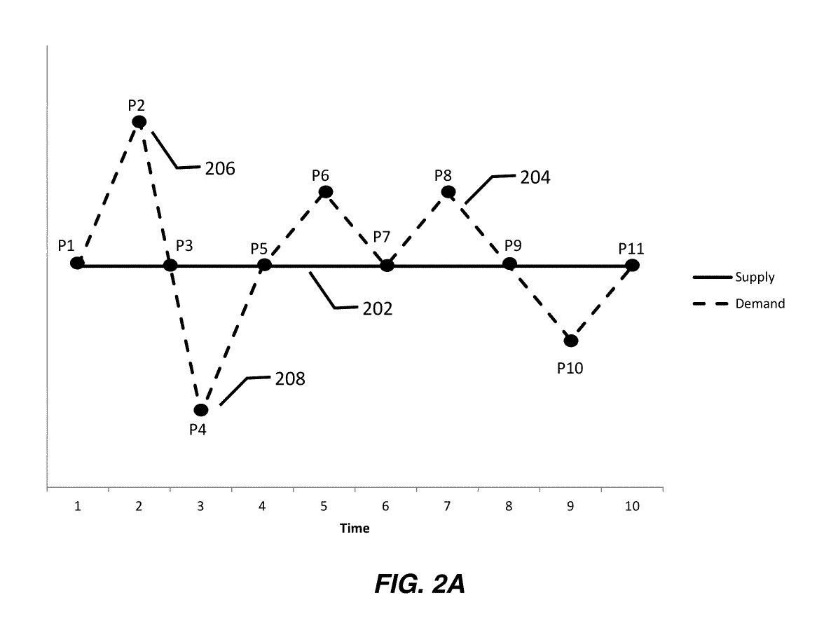

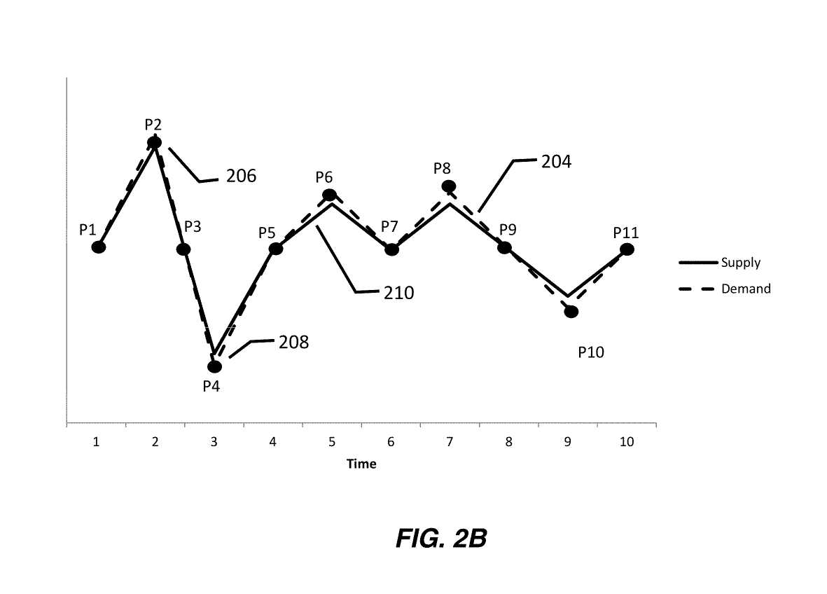

FIGS. 2A and 2B illustrate conceptually cognitive matching of healthcare supply and demand provided by embodiments. FIG. 2A represents a healthcare supply curve 202 and healthcare demand curve 204 over time without task load balancing. Healthcare supply curve 202 represents total cognitive capacity of the healthcare providers in a healthcare facility. Healthcare supply curve 202 can represent cognitive capacity of a particular healthcare provider, group of healthcare providers or an entire facility or system of healthcare providers. Healthcare demand curve 204 represents the healthcare demand, or drain on healthcare provider cognitive bandwidth as patients come into the healthcare facility. As described above, in an embodiment, healthcare demand curve is derived by predicting the tasks that will be required by patients. In an embodiment, the prediction is determined using process mining to predict a diagnosis based on symptoms presented by a patient and identifying tasks at risk required to safely treat the patient.

Each point P1-11 represents a patient that is admitted to the healthcare facility at a certain time. At that time, via process mining, a determination is made as to the expected demand for that patient, that is, what tasks at risk are predicted to be required to treat that patient. Over demand peaks, such as represented by peak 206, represent negative cognitive bandwidth, that is, healthcare demand exceeds the cognitive bandwidth available to meet that demand. This means that not all required tasks at risk will be performed, which will lead to preventable problems meaning that effectiveness is reduced. Under demand as represented by valley 208 represents time where there is not enough healthcare demand to exploit available supply. This means that resources are being underutilized, which results in reduced efficiency. For example, when resources are underutilized, healthcare providers (or other care team members, including the patient or family caregivers) can become bored and complacent. One consequence of such boredom and complacency is that healthcare providers or patients do not train or learn as well (since there is insufficient reinforcement of what is being learned). In the example of FIG. 2A, of the nine patients seen, three (P2, P6 and P8) are at risk of an adverse result due to insufficient resources, i.e., insufficient cognitive bandwidth, available to treat those patients. The adverse results may manifest themselves as poor patient outcomes and/or too much use of resources to treat the patient whether at the current or at a later time.

However, by considering fungible tasks at risk, that is, tasks at risk that can be offloaded to other resources for completion, the supply curve can be made to fit the demand curve. In other words, the difference between the healthcare demand and the available healthcare supply, in terms of cognitive bandwidth, is forced to zero. Reassignment of tasks is different than what was done in conventional systems. In the past, either resources were assigned to patients or patients were moved to available resources. For example, if there were too many patients in a particular area, healthcare resources would be assigned to that area, without any consideration as to whether that will cause them cognitive overload therefore become less efficient. Alternatively, in the past, patients were moved to different areas where there may be less patients, without consideration as to whether the healthcare resources in the area to which the patients are moved can safely and efficiently handle those patients. For example, a patient may have demanding loved ones that require or demand more time (e.g. cancer patients' families will ask a lot of questions and require a lot of reassurance by the physician) of healthcare resources thereby lowering their cognitive bandwidth and lead to less efficient provision of healthcare.

In embodiments, of the present invention on the other hand, it is the fungible tasks, not the patients or the resources, that are reassigned. For example, a doctor may be assigned tasks of reviewing charts, taking patient intake, administering medications, taking patient calls. All of these tasks may overburden the doctor. To alleviate that burden, fungible tasks, such as ordering or administering medications, documenting notes, or taking patient intake histories may be offloaded to other resources, such as nurses or other doctors. Fungible tasks can also include system wide tasks such that can be done via telemedicine.

FIG. 2B represents a healthcare supply curve 210 and healthcare demand curve 304 over time with task load balancing. Referring to FIG. 2B, if tasks at risk, for example those tasks at over demand peak 206 are assigned to available, or fungible healthcare resources, that can have cognitive bandwidth sufficient to handle those tasks, without themselves becoming in danger of nearing or exceeding a tipping point, supply curve 210 will in effect be increased (as compared to healthcare supply curve 202) to match the demand such that patient P2 no longer presents an over demand situation. Similarly, if tasks are assigned to healthcare resources that have excess cognitive bandwidth during times of under demand such as for patient P4, the available supply for patient P4 will be diminished as that cognitive capacity is no longer available due to the different tasks assigned to them.

By reassigning tasks at risk in this manner, the available healthcare supply is tailored to the healthcare demand to improve overall healthcare resource utilization. In addition, because tasks at risk are reassigned based on available cognitive bandwidth of potential healthcare resources, there is no danger of reaching or nearing tipping points through task reassignment.

Focusing on only those tasks at risk, i.e., high value tasks that are at greatest risk of failure due to tipping points being reached, whether due to cognitive overload or cognitive under-load is also referred to as micro-targeting. Micro-targeting allows embodiments to focus on high value tasks that provide the highest likelihood of successful patient outcomes, and avoid wasting time and resources on less valuable tasks that either do not add significantly to successful patient outcomes, do not have a sufficient opportunity window for completion, or for some other reason are less valuable.

Over and undershoot of supply can occur. Supply overshoot occurs when too many tasks are offloaded in a period where healthcare supply is insufficient to meet healthcare demand and therefore the healthcare supply curve overshoots the required healthcare demand. In the event of supply overshoot, all tasks are performed, but at the expense of wasted resources and the associated increased cost. That is, some resources will be underused (which is inefficient), and this problem can then be compounded by the fact that under-loaded resources can reach a “boredom/complacency” tipping point and reduce overall effectiveness.

Supply undershoot occurs when too few tasks are assigned to available healthcare supply in a period where healthcare supply is more than sufficient to meet healthcare demand and therefore the healthcare supply curve undershoots the required healthcare demand. In the event of supply undershoot, not all tasks are performed, which could present a safety issue depending on the task that is not performed. By prioritizing tasks to be accomplished any safety issues that might arise from supply undershoot can be accommodated.

Another source of tasks at risk is the patient. For example, patients must be instructed on how to care for themselves upon discharge from a healthcare facility. Overloaded healthcare providers tend not to provide the required instructions in an efficient manner due to stress, anxiety, etc. Inefficient education results in patients not doing what is required to care for themselves upon discharge from a healthcare facility, which, in turn, results in a higher readmission rates and higher costs to the healthcare facility and the patients. Further, patients, themselves can be a source of their own stress and anxiety, for example, due to pain, length of stay, etc.

Reallocating tasks, or micro-targeting tasks for healthcare providers as described herein to increase cognitive bandwidth of healthcare providers leaves them with the cognitive bandwidth to provide better instruction (more focused teachings communicated in a more clear fashion) to patients, which results in better compliance by the patient when they are discharged from the healthcare facility, and thus fewer readmissions back to the hospital. Similarly, micro-targeting patient education tasks for the patients themselves can increase patient cognitive bandwidth which will enable better learning and absorption of the oftentimes complicated, and too often confusing, medical instructions, and thus improve compliance (and often risk tolerance), which results in fewer readmissions. This can be done in an iterative process using historical data and then considering new data as new patients are processed or over a new data interval, such as a month of new data.

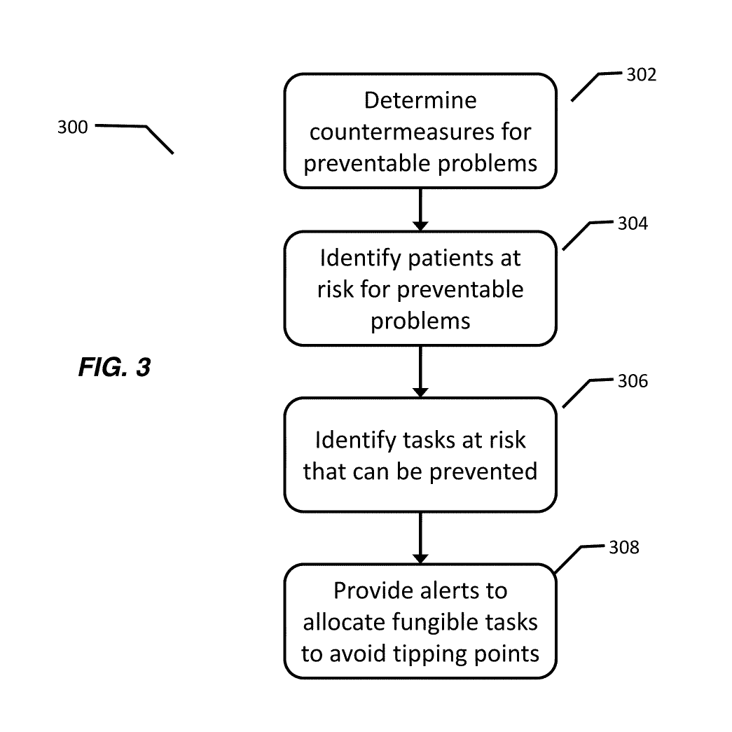

FIG. 3 is a flow chart 300 for a method for managing cognitive bandwidth to prevent failure of valuable tasks requiring cognition according to an embodiment. In step 302, patients at risk for a number of preventable problems (e.g. hospital acquired conditions, readmissions, etc.) are identified. These patients are high opportunity patients because allocating resources to their care is likely to lead to better overall healthcare facility efficiency. Patients presenting more serious conditions and/or requiring higher complexity treatments are considered more at risk. However, patients must also have preventable problems. For example, a patient with a terminal illness has a high mortality score, but a low preventable problem score would not be selected by embodiments.

In step 304, countermeasures for those preventable problems are determined, for example, by looking at in house best practices. In step 306, tasks at risk for the determined countermeasures are identified to help triage and partition treatment. In step 308, alerts are provided to the healthcare team members responsible for caring for patients to avoid tipping points.

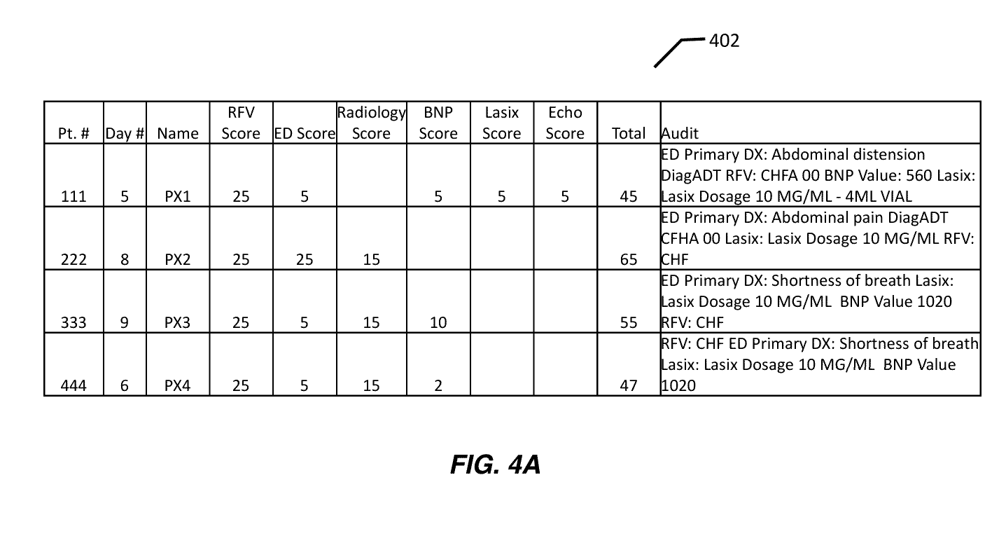

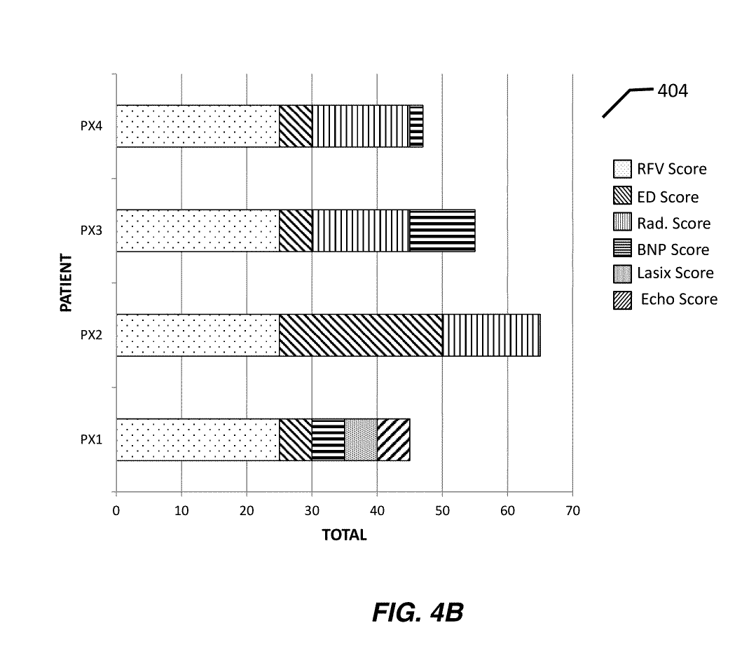

FIG. 4A illustrates an exemplary patient scoring model 402 for scoring symptoms presented by a patient to determine healthcare demand to identify patients at risk. Patient scoring model 402 can be used, for example, in step 302 of flow chart 300. FIG. 4B illustrates in graph 404 of scoring model 402. In an embodiment, scoring is performed by assigning values to various tasks information obtained by searching through hospital records concerning each patient in a healthcare facility. For example, as shown in FIG. 4A, the information considered when treating a patient presenting congestive heart failure includes the reason for the visit, information from the emergency department, and diagnostic information such as information from radiology, Lasix, Echo, and BNP. Additional or other information can be used in embodiments. As shown in FIG. 4A, the information stored in the database can also include an audit trail of all of the information contributing to a score in the scoring model, to reduce the concern on the part of the care team of false positives and thus unnecessary work by them. In an embodiment, the score values are determined empirically, based on historical data. The values are chosen to minimize false positives (indicating a patient is at risk (higher score) when the patient is not at risk) and false negatives (indicating a patient is not at risk (lower score) than when the patient is at risk), with the emphasis on minimizing false negatives. This can be done in an iterative process using historical data and then considering new data as new patients are processed or over a new data interval, such as a month of new data. An exemplary patient scoring model 402 is described in BRENNAN, J. AND VELUSWAMY, R., “A Physician Partnership: Employing Predictive Modeling and Workload Analysis for CHF Performance Improvement,” ACPE Update, AMERICAN COLLEGE OF PHYSICIAN EXECUTIVES, September 2012, which is hereby incorporated by reference herein in its entirety.

After patients at risk are determined, tasks at risk for treating the patients are determined. Determining tasks at risk according to an embodiment comprises a retrospective operation and a concurrent operation.

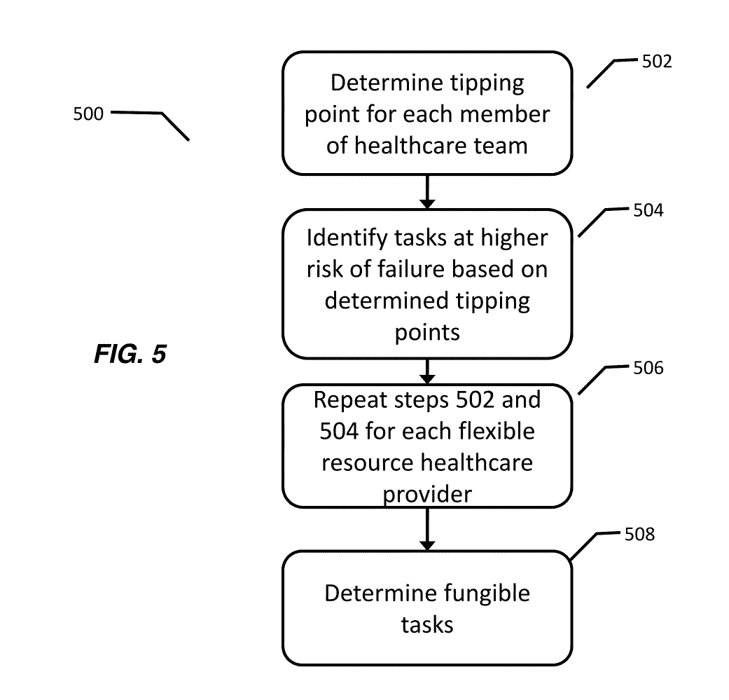

FIG. 5 is a flow chart 500 for performing the retrospective operation for determining a task at risk opportunity score according to an embodiment. In step 502, each member of the healthcare team is analyzed for their tipping point. This tipping point can be if too much load (e.g. the 3^{rd} patient for a doctor of a certain complexity level (e.g. CHF is higher task load and mortality rate and thus cognitive load than Diabetes), but also if too little load (like the doctor having only 1 patient). Thus, in this example, 2 patients is where the error rate on tasks in general is disproportionately lower and thus the performance “sweet spot”. After each healthcare team member's tipping point is determined, in step 502, the tasks that are at higher risk of failure are determined based on the determined tipping points. Different healthcare providers may drop different tasks when overloaded, exhibit different rates of task failure, and also different levels of cognitive load. Thus, each healthcare provider may have a different tipping point.

In step 506, steps 502 and 504 are repeated for each healthcare provider that might be tasked with supporting the current healthcare provider team (flexible resources). The support team comes in to save tasks at risk. But, support healthcare providers must have sufficient cognitive bandwidth to succeed in the rescue as well, so hence the need for getting their tipping point.

In step 508, fungible tasks are determined to identify tasks that can provide relief an overloaded healthcare provider who reaches a tipping points. Fungible tasks are tasks that can be effectively transferred away from the person exceeding their tipping point, whether from the dimension of another person doing it, other tasks of the overloaded person, the same overloaded person doing the task at another time, the person reaching the tipping point doing the task faster and easier from another place (e.g. from home via telemedicine), or another person rescuing the task via tele-health remotely. These determinations of fungibility can be from persons stating the rules of what they can, and are willing to, transfer to others experiencing overload, or can be determined from historical data analysis that shows past transfer of certain tasks, and to whom, thus enabling us to determine how likely a task can be transferred, and to what type of role (based on the persons, like nurses, clerical staff, etc.) or specific persons.

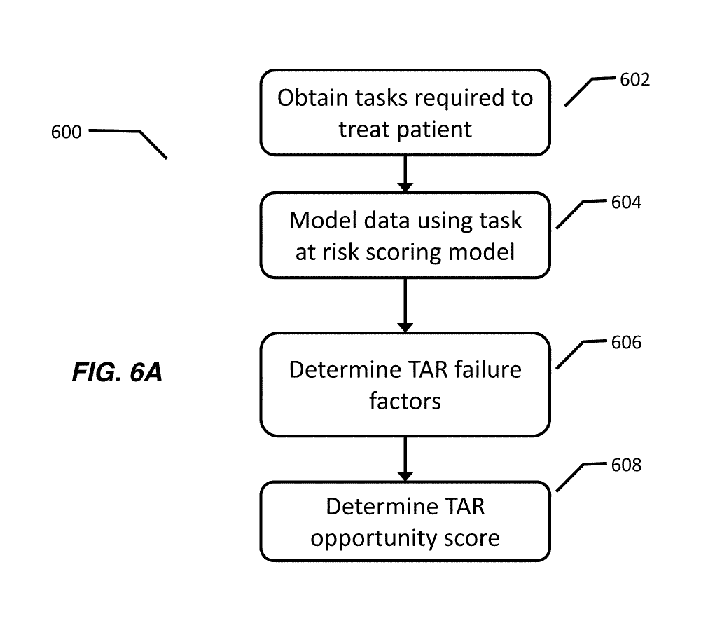

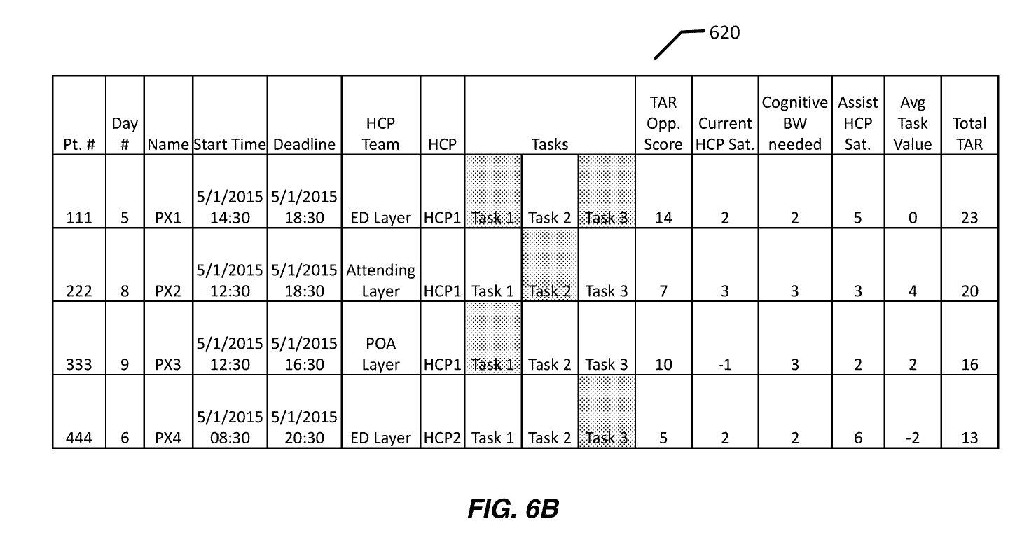

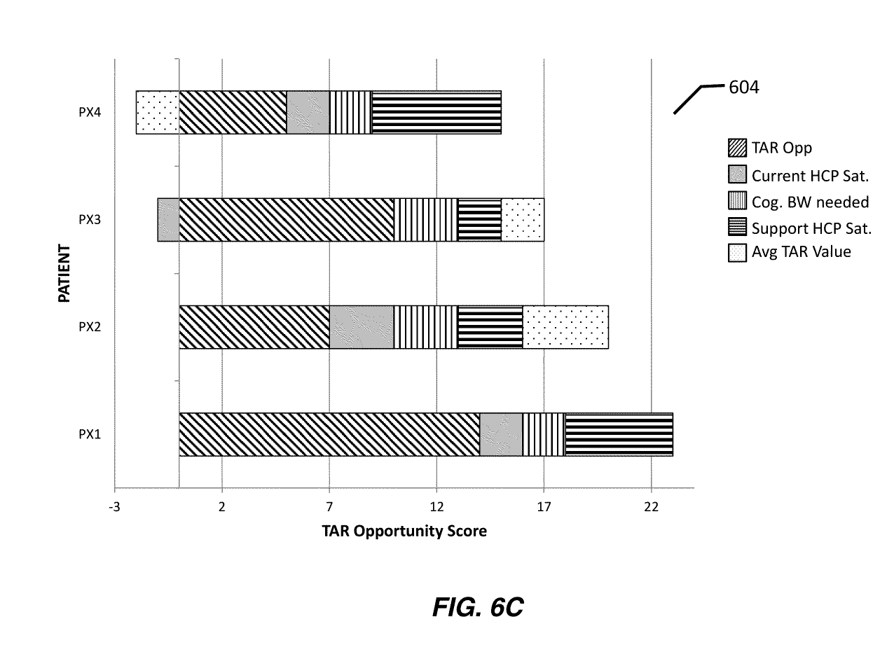

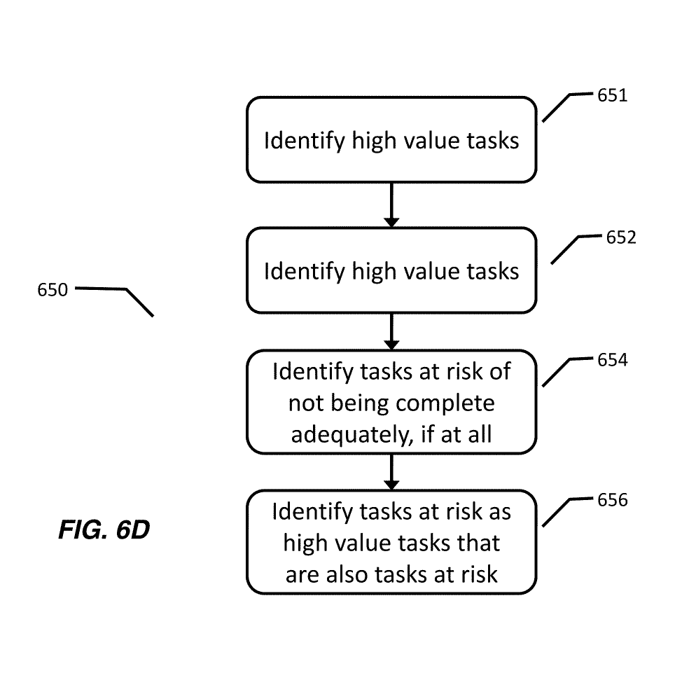

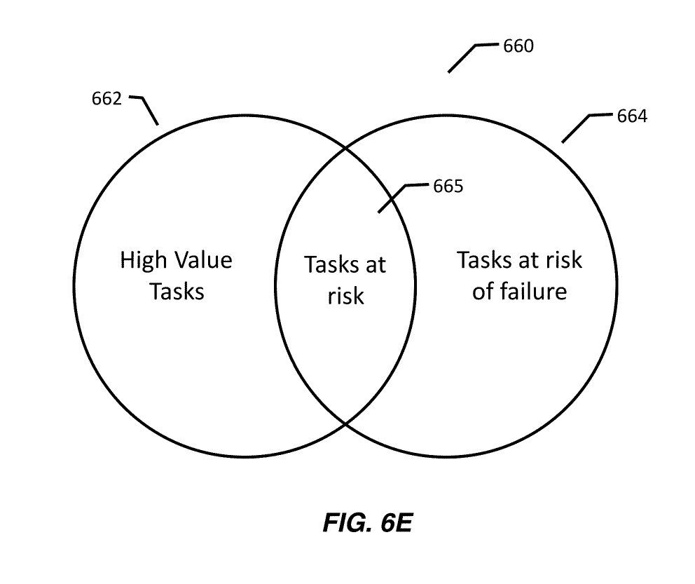

FIG. 6A is a flow chart 600 for performing the concurrent operation for determining a task at risk opportunity score according to an embodiment. In step 602, data is modeled in a patient model such as model 402. This is first step to determining the patients at risk (PAR) score, which indicates the diagnoses the patients have, since this tells us what tasks are required to treat each patient and provides a mortality risk estimate for each patient. For example, the tasks required to treat the patient are obtained from the diagnoses, and mortality risk is determined for all patients for as many diagnoses as can be computed with reasonable predictive value. This determines a cognitive load of the persons concerned with the patient case. In an embodiment, reasonable predictive value is greater than 20% accuracy. This may take place, for example, in step 302 of flow chart 300 described above.

In step 604, data is modeled using a task at risk (TAR) scoring model. FIG. 6B is an exemplary TAR scoring model 620 according to an embodiment. TAR scoring model 620 is used to determine a task at risk (TAR) opportunity score, which is a measure of the ability to apply task at risk countermeasures (TAR CM) to eliminate tasks at risk in treating a patient. FIG. 6C is a graph 622 of the information contained in TAR scoring model 620.

As shown in FIG. 6B, scoring model 620 stores a patient name, a patient identifier, a start time and deadline for determining the opportunity window to take action, tasks that must be performed for the patient, TAR opportunity score, healthcare provider teams that can support tasks (healthcare provider layers in the healthcare continuum of care, healthcare provider within healthcare provider team to whom alert is sent, current healthcare provider (individual and/or team) saturation, cognitive bandwidth needed, support (i.e., flexible resource) healthcare provider (individual and/or team) saturation, average task value, and total task at risk value. The values are chosen to minimize false positives (indicating countermeasures should be performed for the patient when they should will not be successful) and false negatives (indicating countermeasures should not be performed when they would be successful), with the emphasis on minimizing false negatives. This can be done in an iterative process using historical data and then considering new data as new patients are processed or over a new data interval, such as a month of new data.

In practice, there may be more or fewer than three tasks for a particular diagnosis or patient. Shaded tasks in TAR scoring model 620 (tasks 1 and 3 for PX1, task 2 for PX2, task 1 for PX3, and task 3 for PX 4) are tasks that are likely to be done. For example, where a medication has been ordered, it is likely the task (of the patient being administered the medication) will get done, since at least somebody has requested the action and is thus less likely to be forgotten by the team. The remaining tasks are tasks at risk, most likely due to task saturation when the personnel have already been trained and successfully executed the task in the past.

FIG. 6D is a flow chart 650 for determining tasks at risk according to an embodiment. In step 651, the tasks required to treat a patient are determined. As described above, in an embodiment, the tasks required to treat a patient can be determined from the diagnosis of the patient, which is determined from the symptoms the patient presented. In step 652, high value tasks are identified from the tasks determined in step 651. In an embodiment, high value tasks are those tasks required to treat a patient that can be performed within the opportunity window, that is the time allotted to perform a given task. High value tasks can be determined in other ways as well. For example, high value tasks can be determined using evidence-based medicine or comparative effectiveness research. In step 654, tasks identified in step 651 at risk of failure. Tasks at risk of failure are that that might not be performed adequately if at all, or might not be performed within an allotted time. As described above, the tasks at risk of failure, are determined by determining a healthcare provider's cognitive load and comparing how that healthcare provider historically performed under the determined cognitive load. As described above, in an embodiment, this is done by comparing their current cognitive load to their performance under cognitive loads determined retrospectively. In step 656, tasks at risk are identified as those tasks identified in step 651 that are both high value tasks and tasks that are at risk of not being complete adequately, if at all.

FIG. 6E is a Venn diagram 660 that illustrates that tasks at risk are those tasks at the intersection of high value tasks and tasks at risk of failure. High value tasks are represented by circle 662. Tasks at risk of failure are represented by circle 664. Tasks at risk are represented by the intersection 665 of circles 662 and 664.

Thus, embodiments can significantly reduce task load. For example, assume that for a particular patient 10 tasks are required to treat the patient. However, also assume that historical analysis reveals that the healthcare provider drops only one of the tasks when he or she reaches cognitive overload. When performing reviews or double checking, only the one task that would be dropped would be performed by flexible (or support) resources, not all 10, which represents a 90 percent saving over conventional systems in which each task is double checked.

In another embodiment, tasks at risk are determined by looking at high opportunity patients, that is, patient having high cost, but low complexity. The tasks for such high opportunity patients are determined as are the tasks at risk of failure. In such embodiment, tasks at risk are those tasks for high opportunity patients that are at risk of failure.

Referring back to FIG. 6A, in step 606, factors used to determine whether a task at risk has likely failed are determined. In embodiment, these factors include average task value, current healthcare team's saturation (cognitive overload level), cognitive bandwidth needed, and support team saturation (cognitive overload level).

Average task value is a measure of the value of the task in terms of its likelihood of being performed across the number of tasks that need to be performed. It can be based on a number of factors. In an embodiment, one such factor is how many tasks remain to be performed to treat the patient. A lower of number of tasks remaining yields a higher value for the average task value. For example, if 5 tasks at risk are determined to be required to treat the patient, but 4 have already been performed (i.e., 1 task at risk remains), that situation presents a better opportunity for a successful outcome than if only 1 task at risk has been performed (i.e., 4 tasks at risk remain). In addition, average task value also considers how effective the assistant healthcare provider team will be if activated to perform countermeasures to avoid tipping points. This is based on lead time, which is the deadline time for when the TAR CM will still be effective (vs. failing after the deadline given the amount of tasks that must be completed in time) minus the time of the notification. Average task value being high (i.e. to find the high value tasks) can also be based on Evidence Based Medicine, Lean Methodology, Statistical Analysis, and determination of in house best practice tasks at risk countermeasures (IHBP TAR CMs), etc.

Average task value can also be determined empirically based on retrospective data analysis. For example, retrospective data analysis reveals that a first patient presenting a first set of symptoms has a first diagnosis that requires a first treatment comprising a first set of tasks, and that there is only a 10% chance that the predicted diagnosis was correct. Consider a second patient that retrospective data analysis reveals has a second diagnosis that requires a second treatment comprising a second set of tasks, and that there is a 85% chance that the predicted diagnosis was correct. The second patient has a higher average task value, even if the first patient is experience a much more severe malady due to the significantly higher prediction accuracy of the diagnosis.

Average task value can also be viewed mathematically. Process value is preventable efforts' cost of process (e.g., longer ICU stay) less prevention efforts' cost of process (e.g., safety checklist). Average task value then is process value divided by the total tasks in a process, or remaining in a process. Preventable costs are dependent not just on maximum problem cost, but also on the frequency probability of that cost, and most importantly, the TAR risk, since if the task cannot get done, its problem is not preventable. Given limited cognitive bandwidth, there is an opportunity cost of prevention costs. Time and effort spent in prevention that is not beneficial, rather than in other areas, could lead to bad results. When considering average task value, it is important to ensure the TAR has both frontline team bandwidth (including patient) and also the support team bandwidth for achieving the TAR solution.

Current healthcare provider saturation considers task load, for example, what tasks healthcare providers are currently “juggling,” and cognitive tasks from items like mortality risk “worry” exceed the person's pre-determined tipping point (determined in step 502) and consequent cognitive overload level. This can be determined for the current healthcare provider or provider team treating the patient. For example, the current healthcare provider team should have executed the tasks at risk, but may not have due to the cognitive overload. This can be due to a number of things including, for example, the time of day, the time of week, whether the prior layer of healthcare providers missed something and other factors. In an embodiment, determining current healthcare provider saturation is accomplished by looking at current healthcare facility records to see who is assigned to perform what tasks and when.

Cognitive bandwidth needed measures how hidden is a needed task. More hidden tasks require more thinking to identify. For example, the determination as to whether treatment is appropriate, especially if there is higher uncertainty on the diagnoses or lots of treatment options exist, requires substantial cognitive bandwidth. Cognitive bandwidth also considers whether there are factors that can “hide” situations (e.g., infections like pneumonia, which require radiology often to pick up). There are also situations where things are unknown to the current healthcare team at risk for task failure, and which can be picked up by the mismatch of hidden indicators versus the notes of the main team. Obviousness is also a factor affecting cognitive bandwidth needed because the more obvious (e.g., multiple lab values out of norm, or the infection already documented by the team), the less hidden and the less thinking required.

Support (i.e., flexible resource) cognitive healthcare provider saturation is whether the support healthcare providers themselves are in cognitive overload due to task saturation. This can include how many resident physician or mid-level provider (MLP) “options” there are to distribute fungible tasks, what the time of day or day of week (which can indicate quality or administrative staff availability), the team member schedules (for Nurses, MLPS, residents, etc.), and most importantly the current level of cognitive load that the cavalry team members are currently confronting from their routine work as well as these exceptions for TAR they would be asked to do.

Scoring model 620 can store additional metrics for determining the task at risk opportunity score. For example, in an embodiment, scoring model 620 stores information as to whether a prior healthcare layer (the step in the healthcare continuum in which the patient is currently receiving treatment) experienced a cognitive overload. If a prior healthcare layer experienced a cognitive overload, it is more likely a task was not performed correctly, if at all. Such information would be used to increase the total TAR opportunity score.

In embodiments, these factors do not have to be determined in any order, but, are rather updated when new data becomes available or are update according to an interval, for example, monthly. Moreover, values for these factors can be derived empirically based on historical data that seeks to minimize false positives (indicating a countermeasure is needed when it is not) and false negatives (indicating no countermeasure is needed when it is) with the emphasis being on minimizing false negatives.

Scoring model 620 allows prediction of problems (tasks at risk that might fail) so that they recognized the problem and have sufficient time to address it.

Once the factors are determined, in step 608 they are processed to determine a TAR opportunity score. The TAR opportunity score is basically a combination of the factors that predicts whether a task at risk is likely to fail and, if so, whether there is additional support available to provide an effective countermeasure to avoid failure of that task. In an embodiment, for example, a weighting of the factors is used to determine a TAR opportunity score. For example, average task value provides the value of the task. The current healthcare team's saturation level and cognitive bandwidth needed determine whether the current team has sufficient cognitive bandwidth to perform the task or whether additional support is required to prevent failure. The support team saturation level and cognitive bandwidth needed determine whether the support team can handle task offload to prevent failure of the task. Using weightings these values can be combined to derive a TAR opportunity score. The higher the TAR opportunity score, the better the opportunity that failure of tasks at risk can be avoided by implementing various countermeasures.

In an embodiment, micro-targeting selects any task over a predetermined TAR opportunity score threshold. Any patient above the TAR opportunity score threshold is kept for managed alerts. In addition, any healthcare provider who is predicted to have degraded performance is kept for alerts. This, in part, makes the checklist dynamic because which task is at risk can change over time. Another part of the dynamic nature is that the TAR opportunity score threshold may vary depending on available cognitive resources. For example, a variable TAR opportunity score threshold may be based on time of day, where time of day affects resources typically or actually available.

In another embodiment, if all healthcare providers in a layer are overloaded, there is no alert. In an embodiment, the alert is provided to a downstream healthcare provider. This reduces the likelihood of close in time TAR opportunity score alerts as this reduces the effectiveness of each of the TAR alerts. Thus, recipients of particular managed alerts can be changed dynamically. In this case, the TAR opportunity score reflects how valuable, and thus how much concentration went into the alert given the value (and, the desire not to interrupt as described above), However, the number of tasks in an “Safe Transition Checklist”, or STC, and how many minutes each takes determines the amount of time allotted prior to dropping an overload rating on a person to execute the next task noted via alert or some other form of notification. For example, if 2 tasks are required at 5 minutes per task, 10 minutes may be required for the alert, then look at the time the alert was sent and the number of minutes that have elapsed since the alert. If more than 20 minutes, for example, that that person resets to no overload.

In an embodiment, scoring models 402 and 620 are stored in a database for all patients in a healthcare facility. This allows for tracking patients through the continuum of care and to evaluate success of treatment. In an embodiment, the information in the database is accessible on a screen using, for example a report format on the screen.

In an embodiment, the factors including the TAR opportunity score are summed to derive a total TAR opportunity score. Once the total TAR opportunity score is derived for a patient and a current person or team that is at risk of failing at the task at risk, then solutions (an intervention called the task at risk countermeasure that can rescue the task at risk or prevent its failure) must be done proactively within the window of opportunity determined by the retrospective analysis (start time and deadline).

Implementing TAR countermeasures (TAR CM) includes allocating fungible tasks (based on cognitive bandwidth of support healthcare providers) in one of the following ways: (1) cover down (double-check) of the task at risk; (2) direct offload of the task at risk; (3) support healthcare provider or provider team does a different task for the person that has reached their tipping point (to get the task saturated person below their tipping point, rather than rescue task themselves or have another person rescue it). The support healthcare provider or healthcare provider team doing task at risk countermeasures for tasks at risk is assigned tasks at risk to intervene on based on either who in the support healthcare provider or healthcare provider team has the most cognitive bandwidth (for even distribution) or can be assigned tasks at risk to rescue based on getting more to do until they near their tipping point before others are given tasks at risk to address. How tasks at risk are assigned to support healthcare providers or teams is based on preference of the team and its leaders as to which rule to have in place, the latter choice being useful when there is not uniform accountability for the measure, and instead it is concentrated in 1 or a few persons. That should prevent failure of tasks at risk and thus maintain the effectiveness of the process, once the task force assigned to accomplishing these high value tasks are notified which tasks to perform.

Notification can be done through alerting healthcare providers in the healthcare system which tasks they should do. For example, healthcare providers can be provided through daily action plans (DAPs) and/or managed alerts. DAPs are work lists provided to each healthcare provider in a healthcare facility that include the tasks to be performed by that healthcare provider. DAPs can be provided at set intervals, like every 24 hours, 12 hours, etc.

In an embodiment, managed alerts containing countermeasures to avoid tipping points are provided for patients with a corresponding TAR opportunity score that exceeds the TAR opportunity threshold. For example, in an embodiment, managed alerts are provided for all patients that have a corresponding TAR opportunity score that exceeds the TAR opportunity score threshold. In another embodiment, the TAR opportunity scores are ordered from highest to lowest and the managed alerts are distributed accordingly to the extent the cognitive load for the distributed countermeasures does not cause the flexible resources receiving the manages alerts to themselves experience cognitive overload. For example, a managed alert is provided for the patients having the top N TAR opportunity scores exceeding the TAR opportunity score threshold, where N is chosen so that the flexible resource team's cognitive bandwidth is not exceeded. In another example, a managed alert is provided for the patients having the top N TAR opportunity scores exceeding the TAR opportunity score threshold, and wherein if a particular managed alert would cause the receiving flexible resource team's cognitive bandwidth to be exceeded, the particular managed alert would not be sent. Instead, managed alerts are provided for the patient with the next highest score that does not cause cognitive overload of flexible resources and so on. Other ways for distributing managed alerts using thresholds can be devised.

Managed alerts can be used where lead times are too short and cannot wait for the update cycle on the DAP work list. For example, in an embodiment, offloading tasks is accomplished by moving the task to the bottom of the DAP for the healthcare provider offloading the task, and to the top of the DAP for the healthcare provider to whom the task is reallocated.

Managed alerts (or messages) can be sent to healthcare providers using personal communication devices, such as smart phones, tablets, pagers, and any other personal communication device to allocate tasks in a real-time or near real-time basis to avoid tipping points. Thus, when a system according to an embodiment determines that a particular healthcare provider is to be assigned to complete a new task, a message (or alert) is sent to a personal communication device associated with the particular healthcare provider to advise him or her of the new task to be performed. Similarly, if tipping point analysis reveals that a healthcare provider has, or is about to, reach a tipping point, the system may offload one or more tasks from the healthcare provider, and notify the healthcare provider that he or she no longer has to perform those tasks via a message (or alert) sent to the personal communication device associated with the healthcare provider.

In an embodiment, if needed, the alerts are provided in preset intervals, for example, hourly, to reallocate tasks in response to changing conditions in a healthcare facility. In an embodiment, healthcare providers that are at the time of the alert engage in performing a task are not interrupted as interruptions can reduce effectiveness. In an embodiment, an alert is sent at the interval needed to ensure proper response time given the lead time. However, an alert can be blocked if there is no task at risk (i.e., a high value task at risk for failure) with sufficient score to warrant sending an alert (i.e. is too weak), or also if there are no good task at risk countermeasures that can be done in time with a high chance of success (i.e. is too urgent). For example in an embodiment, blocking a managed alert is implementing by adjusting the TAR opportunity score to fall below the TAR Opportunity score threshold. In another embodiment, blocking a managed alert is implemented by software that prevents the managed alert from being issued.

In an embodiment, managed alerts are not sent where the data indicates that although there may be a task at risk, it is already being addressed. Sending an alert in this instance serves no purpose and is, in fact, detrimental because it interrupts the healthcare provider already treating the patient. As a result, a managed alert in this case actually increases the cognitive load on the healthcare provider.

However, managed alerts are sent even when a patient is not experiencing a problem, but the patient is no being treated in an timely appropriate manner. Sending a managed alert in this instance prevents a task at risk from failing even before it starts to fail because treatment for the patient is brought back to where it should be. It also places responsibility further up the healthcare continuum to avoid possibly ending up being treated by last resort healthcare providers such as the ICU or a rapid response team.

Providing managed alerts further up the healthcare continuum of care means that departments or teams treating a patient are more likely to perform all task that are required to be performed so they complete their discharge checklist and can send the patient to the next provider or home. By successfully completing discharge checklists, each healthcare (prevention layer) accomplishes what it is supposed to and does not forward problems to the next layer or department that will treat the patient.

Referring to the example of FIG. 6B, patients PX1 and PX2 have the highest TAR opportunity scores. Task 2 is a task at risk for patient PX1 and tasks 1 and 3 are tasks at risk for patient PX2. Thus, embodiments focus on performing tasks 2 for patient PX2 and tasks 1 and 3 for patient PX2, thereby achieving a 50% reduction in the number of tasks performed. These tasks would then be allocated to healthcare providers, for example, using a daily activity plan, to avoid tipping points.

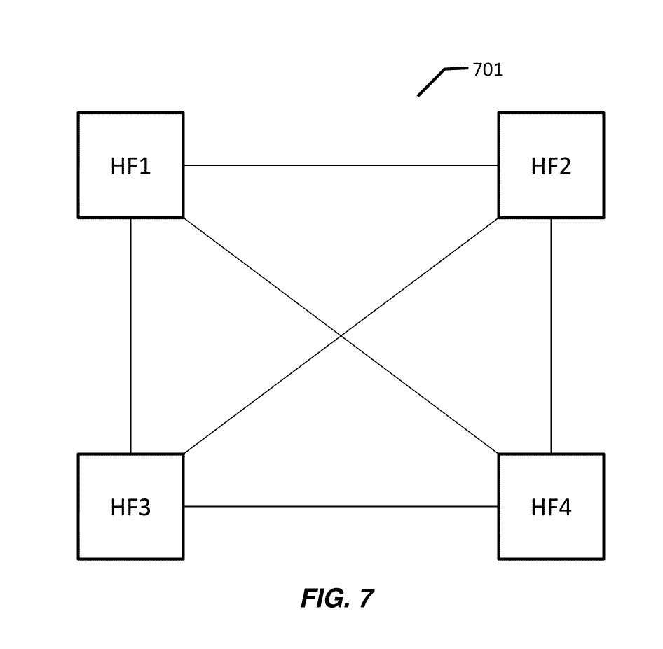

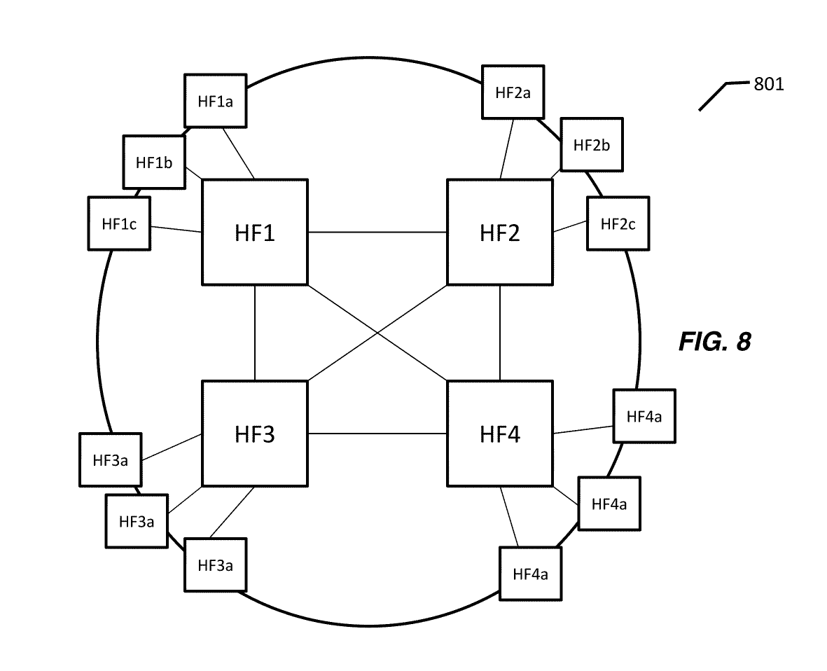

FIG. 7 illustrates an embodiment for interconnectivity between healthcare facilities HF1, HF2, HF3, and HF4 in a healthcare system 701 to allow distributed fungible resources (i.e., flexible resources) for offloading tasks at risk throughout healthcare system 701. Healthcare facilities HF1, HF2, HF3, and HF4 can be in the same healthcare system or in different healthcare systems. In the configurations illustrated in FIGS. 7 and 8, healthcare facilities HF1, HF2, HF3, and HF4 can communicate with one another as to their cognitive levels. For example, if a healthcare facility such as healthcare facility HF2 experiences a cognitive overload by one or more of its team members that would jeopardize a set of tasks and create many more tasks at risk, the PIC module can broadcast a message to healthcare facilities HF1, HF3, and HF4 to advise them of its current situation. Any or all of healthcare facilities HF1, HF3, and HF4 can respond (via their PIC module) as to whether they have sufficient cognitive capacity to handle offloaded tasks from healthcare facility HF2. Healthcare facility HF2 can offload tasks to one or more of healthcare facilities HF1, HF3, and HF4 that indicate they have cognitive capacity to handle the offloaded tasks. Healthcare facilities HF1, HF3, and HF4 can coordinate how much cognitive capacity they have available, and whether they can handle the offloaded tasks alone, or require additional cognitive capacity from one of the remaining healthcare facilities.

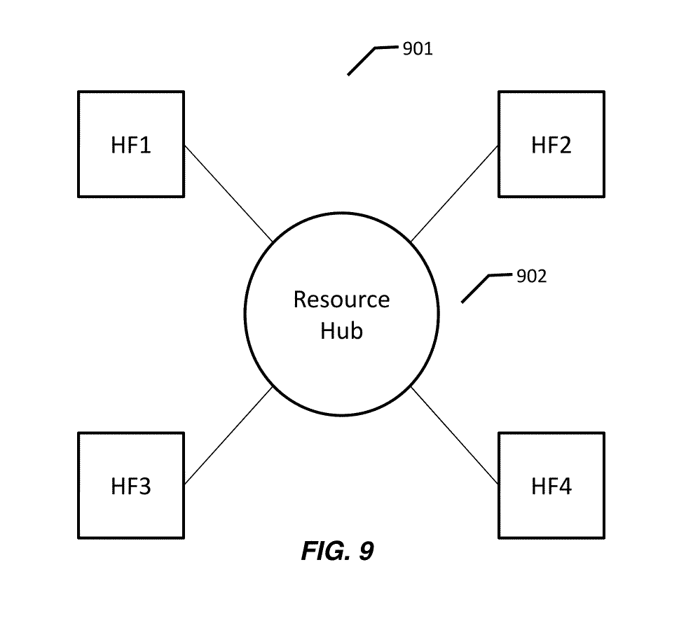

FIG. 8 illustrates a group of healthcare facilities HF1, HF2, HF3, and HF4 in a healthcare system 801 in another configuration to allow distributed fungible resources for offloading tasks at risk throughout healthcare system 801. As shown in FIG. 9, a healthcare facility HF can have additional healthcare facilities such as clinics or doctor's offices, or other healthcare facilities that they are associated with. For example, healthcare facility HF1 is associated with additional healthcare facilities HF1a, HF1b, and HF1c; healthcare facility HF2 is associated with additional healthcare facilities HF2a, HF2b, and HF2c; healthcare facility HF3 is associated with additional healthcare facilities HF3a, HF3b, and HF3c; and healthcare facility HF4 is associated with additional healthcare facilities HF4a, HF4b, and HF4c. Healthcare facilities HF1, HF2, HF3, and HF4 perform capacity surveillance of their associated additional healthcare facilities. Should one or more of the associated additional healthcare facilities experience cognitive overload, the associated healthcare facility can offload tasks to its resources, or those of any other healthcare facility that may have excess cognitive capacity to apply to handle the tasks to be offloaded. In addition, in an embodiment, the tasks may be offloaded to one or more additional healthcare facilities associated with a different healthcare facility. This is done via “shared cognitive capacity” that may be located at one or more of the facilities, but are essentially flexible resources that can perform fungible tasks throughout the network of facilities.

For example, suppose additional healthcare facility HF1a experiences cognitive overload. Either it, or healthcare facility HF1 will determine tasks that can be offloaded to another healthcare facility or additional healthcare facility that has healthcare resources with cognitive bandwidth sufficient to handle the tasks to be offloaded without themselves going into cognitive overload. Similarly, if additional healthcare facility HF1a experiences cognitive under-load, either it, or healthcare facility HF1 will advise other healthcare facilities in healthcare system 401 of additional healthcare cognitive capacity that they can use if they experience healthcare cognitive overload.

The system of FIGS. 7 and 8 works as healthcare facilities tend to experience cognitive overload at different times, and therefore one or more tend to have excess cognitive capacity when another is experiencing cognitive overload. Therefore, during such periods of cognitive overload, tasks can be reassigned for completion by resources in healthcare facilities having available cognitive capacity. For example, if healthcare facility HF2 experiences a period of cognitive overload, tasks being performed by HF2 resources can be reassigned to one or more healthcare facilities that have excess cognitive bandwidth, such as healthcare facility HF1. Reassigning tasks in this manner reduces the cognitive bandwidth of healthcare facility HF2 to alleviate overload, and does not require additional staff at healthcare facility HF1 that may otherwise be idle to some extent at certain times. This excess capacity can complement the other facilities that may be experiencing team member cognitive overload at that time. The greater the size of the network of providers or care team members, and the fungible tasks they can share, the greater the value afforded the network (following Metcalfe's Law/Network Effect as the network grows, and following Pareto's Rule wherein just a few changes can result in a significant value increase). The reduction of risk possible, as well, is similar to diversification in a stock portfolio, where fluctuations in supply and demand are smoothed, thus keeping team members in their sweet spot of performance to workload.

Another advantage provided by the structure of FIGS. 7 and 8 is that one or more healthcare facilities HF1, HF2, HF3, and HF4 can have healthcare resources that are specialized to particular tasks (i.e. for comparative advantage). Because of fungible task offloading, tasks requiring a certain specialty can be assigned to the healthcare facility with the specialized healthcare resources. In this way, only one group of a particular specialty at one healthcare facility is required rather than each healthcare facility having redundant groups.

FIG. 9 illustrates a healthcare system 901 showing a hub of flexible cognitive resources that can service healthcare facilities in a healthcare system. A centralized resource hub 902 contains fungible (not necessarily by physically moving them around the network, but rather enabling them to work on tasks that benefit other facilities' teams) healthcare resources that can be assigned fungible or partitionable tasks to perform. In an embodiment, these tasks can be performed remotely, for example, by tele-health. Resource hub 902 performs capacity surveillance across healthcare facilities HF1, HF2, HF3, and HF4. Healthcare facilities HF1, HF2, HF3, and HF4 can be in the same healthcare system or in different healthcare systems. Capacity surveillance applies process mining and lead time intervention analysis to determine which facilities have tasks at risk. Then, resource hub 902 assigns those tasks causing a healthcare facility to experience cognitive overload to be completed by resources in resource hub 902.

Resource hub 902 can be centralized in a virtual sense. That is, it does not have to be physically located in the center of a healthcare system. All that is required is that it be able to communicate with each of healthcare facilities HF1, HF2, HF3, and HF4.

Using a resource hub healthcare facility spoke structure as shown in FIG. 9 significantly reduces costs because fewer centrally located resources are required to perform the required tasks, than would be required if separate resources were located in each of healthcare facilities HF1, HF2, HF3, and HF4. One reason for this is that cognitive load varies over time for each of healthcare facilities HF1, HF2, HF3, and HF4. As a result, cognitive overload often occurs at different times for healthcare facilities HF1, HF2, HF3, and HF4. During such periods of cognitive overload, tasks can be reassigned for completion by resources in resource hub 902. For example, if healthcare facility HF1 experiences a period of cognitive overload, tasks being performed by HF1 resources are reassigned for completion by resources in resource hub 902. Reassigning tasks in this manner reduces the cognitive bandwidth of healthcare facility HF1 to alleviate overload, and does not require additional staff at healthcare facility HF1 that may otherwise be idle.

Resource hub 902 can be centralized in a virtual sense. That is, resource hub 902 does not have to be physically located in the center of a healthcare system. In an embodiment, resource hub 902 is located in one of healthcare facilities HF1, HF2, HF3, or HF4. In another embodiment, resource hub 902 is distributed in a plurality of healthcare facilities HF1, HF2, HF3, and HF4.

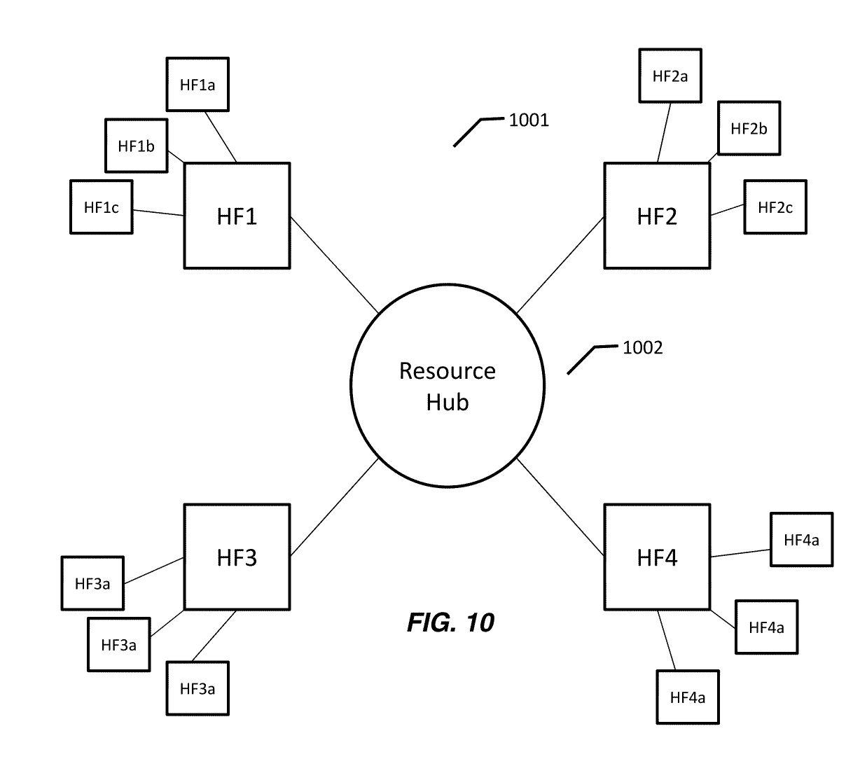

FIG. 10 illustrates a healthcare system 1001 with healthcare facilities HF1, HF2, HF3, and HF4 of FIG. 9 each have additional healthcare facilities associated with them. For example, healthcare facility HF1 is associated with additional healthcare facilities HF1a, HF1b, and HF1c; healthcare facility HF2 is associated with additional healthcare facilities HF2a, HF2b, and HF2c; healthcare facility HF3 is associated with additional healthcare facilities HF3a, HF3b, and HF3c; and healthcare facility HF4 is associated with additional healthcare facilities HF4a, HF4b, and HF4c. In the embodiment illustrated in FIG. 10, resource hub 1002 also performs capacity surveillance on the additional healthcare facilities. In another embodiment, each healthcare facility HF1, HF2, HF3, and HF4 performs capacity surveillance on its respective associated additional healthcare facilities, and provide the results to resource hub 1002. In either case, using information it finds itself or it obtains from one or more healthcare facilities, resource hub 1002 reassigns tasks as appropriate to avoid any healthcare facility or additional healthcare facility from experiencing cognitive overload.

The structure of FIGS. 9 and 10 provide an additional benefit. To exchange health information in the United States, the healthcare facilities between which the information is to be exchanged must enter into a business associate agreement (“BAA”). With the structures of FIGS. 7 and 8, a number of BAAs is required due to the connectivity between the various healthcare facilities of the system. However, in the embodiment shown in FIGS. 9 and 10, only one BAA is required as resource hub 902 or 1002 communicates required healthcare information with each healthcare facility HF1, HF2, HF3, and HF4, thereby relieving the healthcare facilities from communicating healthcare information between themselves. This is true also for the case where the healthcare facilities have additional associated healthcare facilities so long as each additional associated healthcare facility communicates directly with resource hub 902 or 1002.

Task reassignment in any of the healthcare system configurations illustrated in FIGS. 7-10 can be by any means of communication, including for example, telephone, text, email, page, facsimile, etc. Faster forms of communication such as text and email are required to meet real time or near real time applications.

Another advantage of the healthcare system configurations illustrated in FIGS. 7-10 is that determining cognitive capacity on a system-wide basis allows the system to predict whether it has sufficient cognitive bandwidth to handle a surge in healthcare demand. For example, if a disease is known to be present in a system, knowing the cognitive capacity of the system will allow prediction of whether the disease will be treatable in time before it is too late for mortality or large cost requirements.

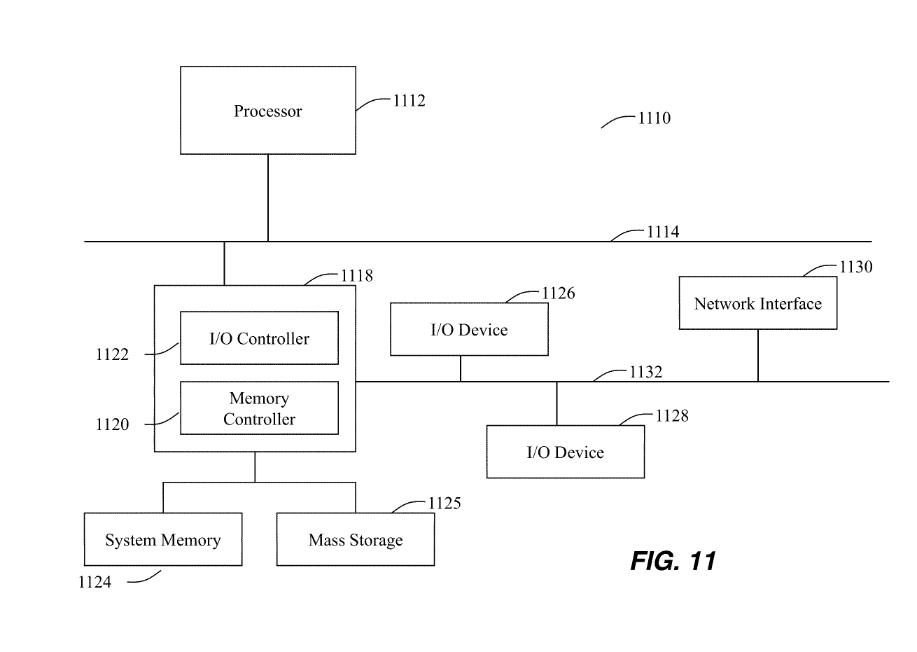

In an embodiment, at least one computer in each healthcare facility is configured to carry on the communications described herein. FIG. 11 is a block diagram of an example computer 1110 that may be used to implement the apparatus and methods described herein, including for example, computers in the healthcare facilities, according to an embodiment of the present invention. As shown in FIG. 11, computer 1110 includes a processor 1112 that is coupled to an interconnection bus 1114. Processor 1112 may be any suitable processor, processing unit or microprocessor. Although not shown in FIG. 11, system 1110 may be a multi-processor system and, thus, may include one or more additional processors that are identical or similar to processor 1112 and that are communicatively coupled to interconnection bus 1114.

Processor 1112 of FIG. 11 is coupled to a chipset 1118, which includes a memory controller 1120 and an input/output (“I/O”) controller 1122. As is well known, a chipset typically provides I/O and memory management functions as well as a plurality of general purpose and/or special purpose registers, timers, etc. that are accessible or used by one or more processors coupled to the chipset 1118. The memory controller 1120 performs functions that enable the processor 1112 (or processors if there are multiple processors) to access a system memory 1124 and a mass storage memory 1120.

System memory 1124 may include any desired type of volatile and/or non-volatile memory such as, for example, static random access memory (“SRAM”), dynamic random access memory (“DRAM”), flash memory, read-only memory (“ROM”), etc. The mass storage memory 1125 may include any desired type of mass storage device including hard disk drives, optical drives, tape storage devices, etc.

The I/O controller 1122 performs functions that enable the processor 1112 to communicate with peripheral I/O devices 1126 and 1128 and a network interface 1130 via an I/O bus 1132. I/O devices 1126 and 1128 may be any desired type of I/O device such as, for example, a keyboard, a video display or monitor, a mouse, etc. Network interface 1130 may be, for example, an Ethernet device, an asynchronous transfer mode (“ATM”) device, an 802.11 device, a DSL modem, a cable modem, a cellular modem, etc. that enables processor system 1110 to communicate with another computer such as a local computer or remote computer located in another healthcare facility or in an additional healthcare facility.

While memory controller 1120 and I/O controller 1122 are depicted in FIG. 11 as separate blocks within chipset 1118, the functions performed by these blocks may be integrated within a single semiconductor circuit or may be implemented using two or more separate integrated circuits.

By allocating tasks in advance according to embodiments, cognitive overload in healthcare providers is significantly reduced if not eliminated. This leads to healthcare providers, for example physicians, being more comfortable with tasks being offloaded to others in the healthcare delivery team, for example nurses or mid-level providers like physician assistants or nurse practitioners. The offloading in turn increases cognitive capacity of the healthcare providers, for example doctors, which allows them to treat more patients per day and increase healthcare facility “safe throughput” for the nation's current concern with wait times, facility revenues from the higher volume, and even the physicians income if it is tied to seeing more patients at a higher quality level. High value task throughput of the team is ultimately what is increased by the invention.

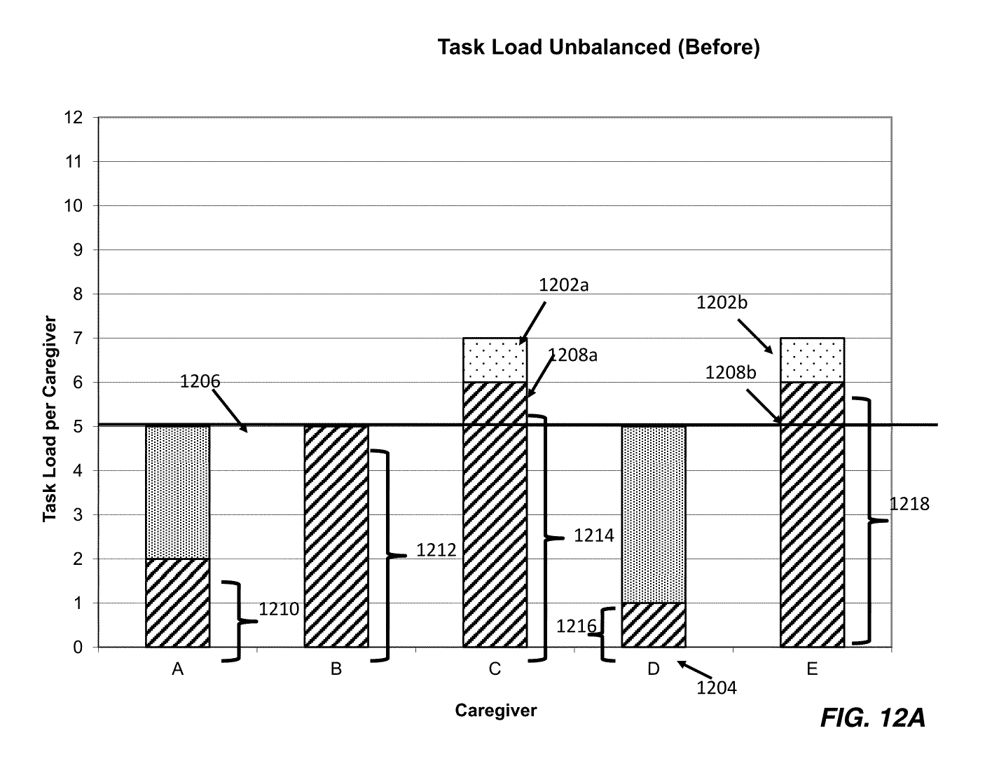

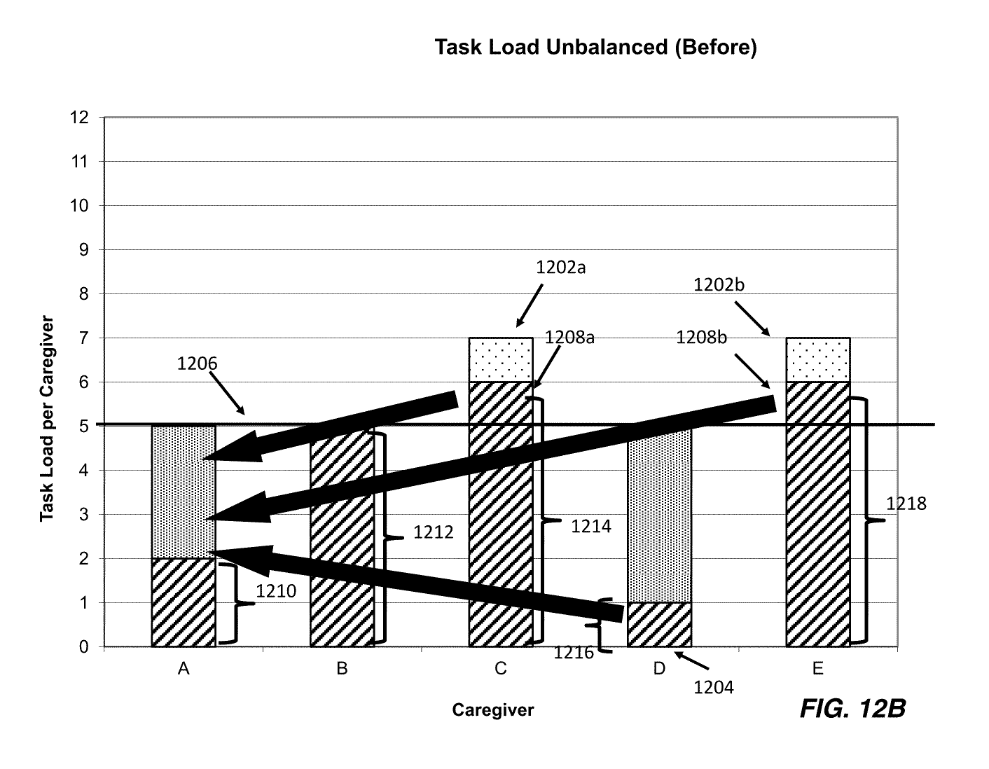

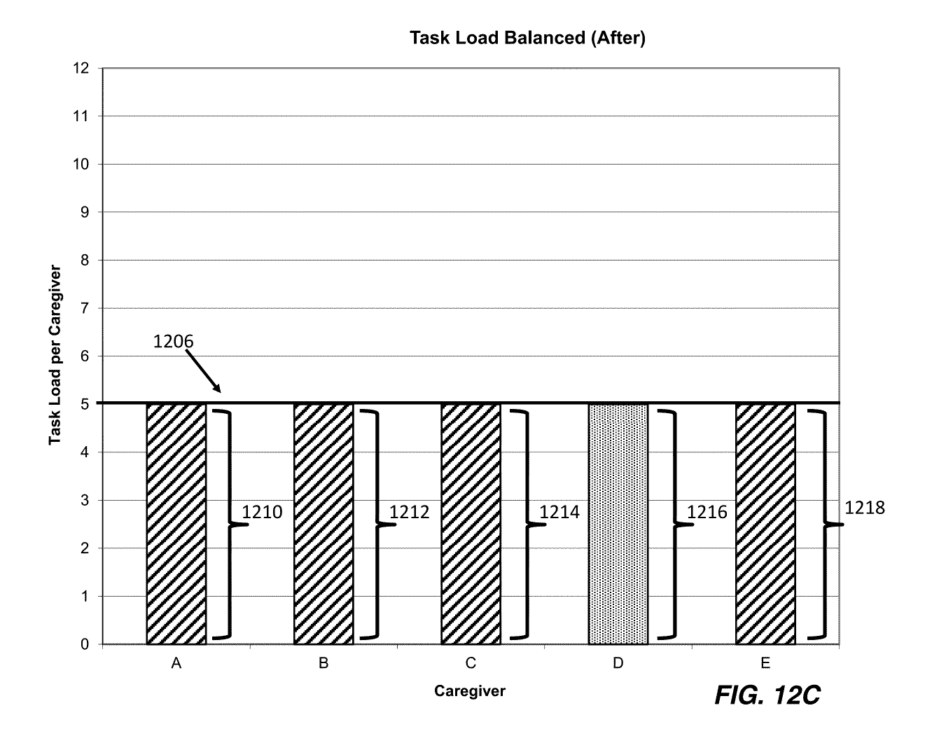

FIGS. 12A-12C illustrate an example of process redesign using cognitive modeling. FIG. 12A represents an unbalanced task load in an entity. FIG. 12A illustrates an unbalanced task load for 5 healthcare providers A-E. The tipping point for each individual has been determined as 5 tasks per person as shown by line 1206. Provider A has a task load 1210 of 2 tasks. Provider B has a task load 1212 of 5 tasks. Provider C has a task load 1214 of 7 tasks. Provider D has a task load 1216 of 1 task. Provider E has a task load 1218 of 7 tasks.

In this scenario, healthcare providers C and E are overloaded as represented by tasks 1202a, 1202b, 1208a, and 1208b. Task overload leads to avoidable tasks and unnecessary work and staff. In the example, tasks 1202a and 1202b are avoidable overload tasks. Tasks 1208a and 1208b are not avoidable tasks. Healthcare provider D is under-loaded as shown by task 1204. Task under-load leads to too many staff.

As described above, and shown in FIG. 12B, tasks are intelligently reallocated to healthcare providers with excess capacity such as healthcare provider A and away from those healthcare providers, such as healthcare providers C and E that are faced with cognitive overload. As shown in FIG. 12B, not only can tasks be moved away from those healthcare providers facing cognitive overload, but they can also be moved away from those healthcare providers facing cognitive under-load. For example, in the example of FIG. 12B, an unavoidable task is offloaded from overloaded healthcare providers C and E and given to healthcare provider A. In addition, even though under-loaded, provider D's task is also offloaded to provider A.

As shown in FIG. 12C, this reallocation of tasks has the effect of fully loading provider A and bringing both provider C and provider E to within their 5-task tipping point. Moreover, the task reallocation frees provider D to perform other tasks, or to reduce staffing requirements. That is, provider A, B, C, and E each have been allocated 5 tasks, and provider D was allocated zero tasks as shown by task loads 1210, 1212, 1214, 1216, and 1218 in FIG. 12C.

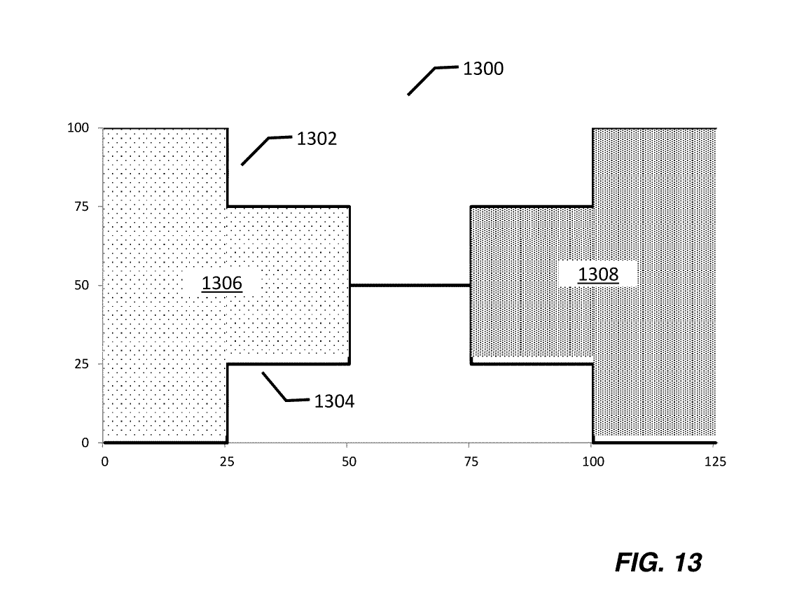

Tasks at risk analysis can be performed for patients as well as healthcare providers. FIG. 13 is a graph 1300 that illustrates the effects of a hospital stay on patients and the physiologic changes they can go through that affect their ability to learn and absorb information. Curve 1302 represents an exemplary cognitive load on the patient. Curve 1034 represents an exemplary cognitive capacity of the patient. Area 1306 represents an area where the patient's cognitive capacity exceeds cognitive load, that is, the patient has positive cognitive bandwidth. In area 1306, the patient can learn and absorb information for his or her care adequately. Area 1308 represents an area where the patient's cognitive load exceeds cognitive capacity, that is, the patient has negative cognitive bandwidth. In area 1308, the patient cannot learn and absorb information for his or her care adequately. As such, countermeasures to lower the cognitive load on care instructions given to patients can be an important factor in ensuring that patients learn and absorb the information required for their care when they are discharged from the hospital.

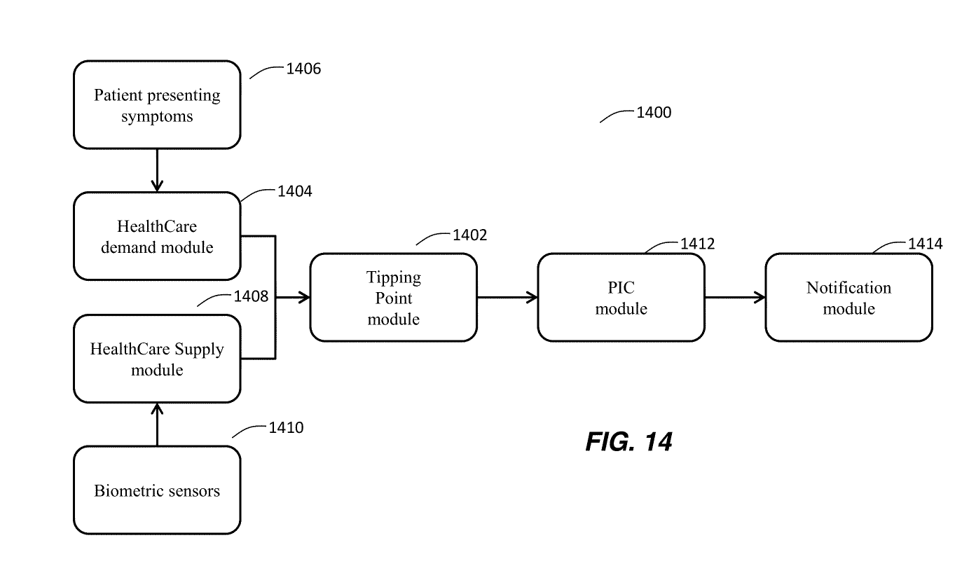

FIG. 14 is a system for managing cognitive bandwidth in an organization using a performance improvement coordinator (PIC) module. A PIC module is a routine executing on computers such as computer 1110 that is configured to perform the TAR analysis described herein. In an embodiment, the PIC module uses information from other modules to perform the TAR analysis described herein to identify opportunities for preventing tasks at risk from failing as described above.

FIG. 14 illustrates a system 1400 for managing cognitive bandwidth by allocating tasks according to an embodiment. Healthcare demand module 1402, healthcare supply module 1404, tipping point analysis module 1408, PIC module 1412, and notification module 1414 can be implemented on a computer, such as computer 1110, configured with the described modules. The computer can be connected to a network (e.g., Internet, intranet, LAN, WAN, etc.) so the modules can obtain information, such as patient symptoms and diagnoses, from other computers on the network. When located on another computer, the information is accessed via a network.

In the exemplary embodiment illustrated in FIG. 14, a healthcare demand module 1404 inputs patient presenting symptoms 1406 (and can also include lab results, radiology test, and other patient health data sampled over time). In an embodiment, this is done using process mining, for example, lexical analysis of intake reports that include symptoms presented by patients. Other sources for patient presenting symptoms, such as ER reports, patient intake interviews, etc., can also be used. These sources can be located on a on a mass storage device connected to system 1400 or stored on one or more computers that are located locally or remotely to system 1400. When the sources are stored on another computer, they are accessed via a network.

Healthcare demand module 1404 determines tasks that are required based on the symptoms. For example, in an embodiment, healthcare demand module 1404 predicts the required tasks based on the presenting symptoms by accessing one or more databases that correlates symptoms with a diagnosis. The database(s) also correlate each diagnosis with an in house best practices (“IHBP”) checklist that contains tasks to perform to treat the diagnosis for the resources available in the organization, so that the best practice is practical in the organization, and not simply a best practice that worked well at another facility with a different set of resources and consequent capabilities. The database(s) can be located on a on a mass storage device connected to system 1400 or stored on one or more computers that are located locally or remotely to system 1400. When the database(s) are stored on another computer, they are accessed via a network.

Healthcare supply module 1408 determines the available healthcare supply that can be used to handle the tasks. In an embodiment healthcare supply can be determined based on a number of factors including healthcare providers and their capabilities, and available healthcare resources, including for example, available equipment, rooms, and other facilities. In an embodiment, real time analysis of healthcare provider physical attributes provided by biometric sensors 1410. The real time biometric data is used in an embodiment to provide a real time indication of stress levels, which affects cognitive capacity. For example, the higher the stress, the less a person is able to function efficiently, that is, the lower their cognitive capacity. Other sensors can be found in Smartphone devices (e.g. accelerometers, time-keeping devices, GPS tracking devices, etc.), and even from the data available on various systems like time clock systems, and information systems that note who is in the hospital, and how many patients they are assigned to, taking notes on, etc.

Using the determinations from healthcare demand module 1404 and healthcare supply module 1408, tipping point module 1402 determines tipping points for each available healthcare provider based on their cognitive bandwidth and current actual and/or predicted cognitive load. Using the determined cognitive bandwidth information, healthcare supply module 1408 determined which tasks are tasks at risk. This information is provided to a PIC module 1412 to allocate required tasks to available healthcare providers to avoid tipping points, and thereby ensure tasks at risk are completed to increase patient safety and successful outcomes. To allocate the tasks, PIC module 1412 assigns tasks through a notification module 1414. For example, notification module 1414 can send email messages, text messages, telephone calls or other notifications to healthcare providers to assign tasks and reallocate tasks, including assigning and reallocation in real time. Additionally, notification module 1414 can make daily activity reports to assign daily tasks that it provides to healthcare providers on a desired interval, such as daily or every 4 hours. In an embodiment, there is no notification module 1414. In such case, PIC module 1412 provides the information to a human who configures the alerts or creates the DAPs.

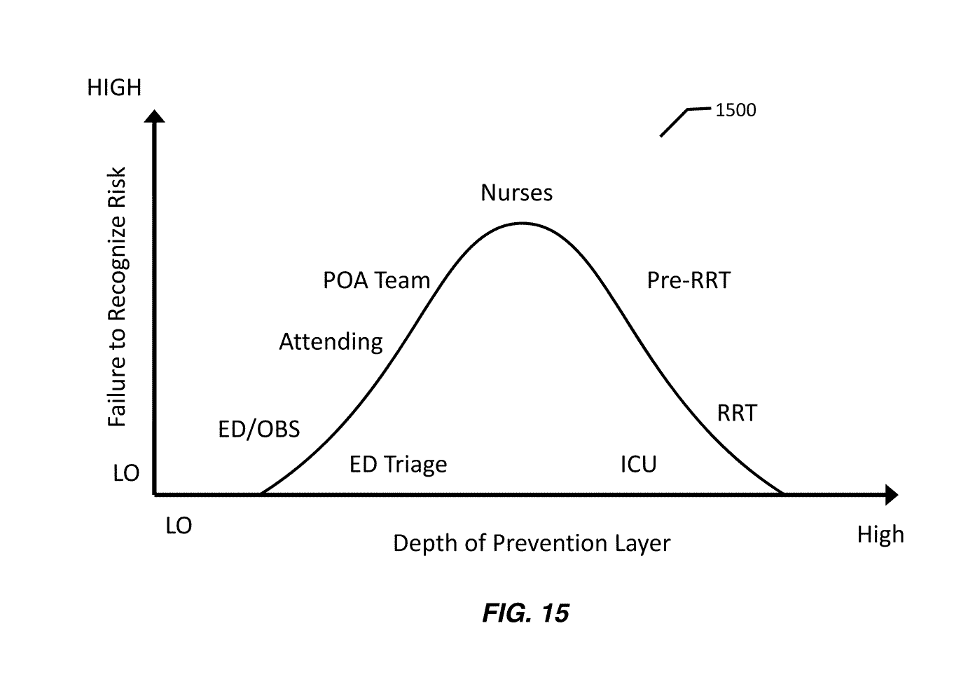

A PIC module, such as PIC module 1412, can analyze data for one or more points in the healthcare continuum to prevent failures of tasks at risk. FIG. 15 illustrates an exemplary healthcare care continuum 1500. The POA (present on admission) team and the pre-RRT (Rapid Response Team) represent support healthcare providers at different layers or stages of the healthcare continuum. For example, in an embodiment, the POA team is used to offload tasks from frontline healthcare providers such as emergency department providers and attending physicians and pre-RRT is used to offload tasks from frontline healthcare providers such as nurses. In an embodiment, the POA team is activated when a history and physical is available, and whatever medications and management might be available prior to the 48-hour time limit deadline from the admission time. In an embodiment, the pre-RRT is activated when there is no urgency on vitals and there is enough lead time before the Rapid Response Team and ICU are called, and where there may be other data, such as documented vitals, etc. help identify best opportunities for preventing failures of tasks at risk. By attempting to prevent failures of tasks at risk earlier in the healthcare continuum of care, the likelihood of patients being discharged to downstream layers with problems is reduced, which conserves the cognitive bandwidth of the downstream layer healthcare providers, who do not have to consume cognitive bandwidth to fix the problems.

Embodiments of the present invention may demonstrate significant efficiency improvements in organizational efficiency. For example, in a typical alerting environment, there may be 10 patients with 10 tasks, each requiring 30 seconds to perform, and there are 5 healthcare provider team members to alert. In this case, there are 250 man-minutes (more than 4 man hours) consumed to perform the alerting. However, if the task at risk analysis described above, micro-targets the alert for a single healthcare provider team members and identifies only 5 TARs, then the alerting consumes only 25 man minutes.

The tasks-at-risk analysis and tipping point analyses described above are not limited to healthcare entities. It can be applied to any metric that an entity is trying to improve. For example, tasks at risk in the healthcare environment apply to mortality, infection, complications, etc. In each case, process mining is used to probabilistically determine the tasks at risk by looking at the tasks that were not done or were not done sufficiently, and considering the cognitive bandwidth on the healthcare providers that were responsible for those tasks, to determine the tasks at risk, which will lead to a particular outcome some percentage of the time.

It is to be understood that the description, specific examples and data, while indicating exemplary embodiments, are given by way of illustration and are not intended to limit the various embodiments of the present disclosure. All references, information contained in a website, and the like, cited herein for any reason, are specifically and entirely incorporated by reference. Various changes and modifications within the present disclosure will become apparent to the skilled artisan from the description and data contained herein, and thus are considered part of the various embodiments of this disclosure.

What is claimed is:

1. A method for managing cognitive bandwidth in a healthcare organization, comprising:
determining a diagnosis for a patient based on one or more symptoms presented by the patient;
determining one or more tasks to perform to treat the patient based on the determined diagnosis;
determining a cognitive capacity of a healthcare provider team that is responsible for caring for the patient;
determining tasks at risk for treating the patient;
determining a task at risk opportunity score for treating the patient; and
allocating the tasks at risk to avoid reaching a tipping point of any healthcare provider in the healthcare provider team.

2. The method of claim 1, wherein determining the task at risk opportunity score comprises:
determining a cognitive load needed score;
determining a cognitive load of the healthcare provider team score;
determining a cognitive load of a flexible resource team score;
determining an average task value for the tasks at risk; and
summing the determined cognitive load needed score, the cognitive load of the healthcare provider team score, the cognitive load of the fungible resources team score, and the average task at risk value to calculate the task at risk opportunity score.

3. The method of claim, further comprising:
identifying high value tasks from the one or more tasks to perform to treat the patient;
identifying tasks that are at risk of failure from the one or more tasks to perform to treat the patient; and
determining as tasks at risk those tasks identified both as high value and as at risk of failure.

4. The method of claim 1, further comprising deriving the task at risk opportunity score to minimize both false positives and false negatives.

5. The method of claim 1, further comprising determining high opportunity patients and only analyzing the determined high value patients.

6. The method of claim 1, further comprising:
determining that a healthcare provider in the healthcare provider team has reached cognitive overload; and
performing one of:
double checking a task at risk of the healthcare provider experiencing overload;
offloading a task at risk from the healthcare provider experiencing overload to a flexible resource in the flexible resource team; and
delaying performance of a task at risk that the healthcare provider experiencing overload was supposed to perform.

7. The method of claim 1, further comprising notifying at least one healthcare provider in the healthcare provider team of a change in tasks at risk to perform.

8. The method of claim 7, further comprising:
preparing a daily action plan listing tasks to be performed by a healthcare provider; and
distributing the daily action plan to at least one healthcare provider in the healthcare provider team.

9. The method of claim 1, further comprising:
determining if the task at risk opportunity score exceeds a threshold; and
allocating the tasks at risk for the patient when the task at risk opportunity score exceeds the threshold.

10. The method of claim 1, further comprising storing the determined cognitive load needed score, the cognitive load of the healthcare provider team score, the cognitive load of the fungible resources team score, and the average task at risk value in a task at risk scoring model.

11. A system for managing cognitive bandwidth in a healthcare organization, comprising:
a healthcare demand module to determine a diagnosis for a patient based on one or more symptoms presented by the patient and one or more tasks to perform to treat the patient based on the determined diagnosis;
a tipping point module to determine a cognitive capacity of a healthcare provider team that is responsible for caring for the patient;
a performance improvement coordinator (PIC) module to determine tasks at risk for treating the patient and a task at risk opportunity score for treating the patient, and to determine a task at risk allocating to allocate tasks at risk to avoid reaching a tipping point of any healthcare provider in the healthcare provider team; and
a notification module to notify one or more healthcare providers of tasks at risk they are to perform.

12. The system of claim 11, wherein to determine the task at risk opportunity score, the PIC module further:
determines a cognitive load needed score;
determines a cognitive load of the healthcare provider team score;
determines a cognitive load of a flexible resource team score;
determines an average task value for the tasks at risk; and
sums the determined cognitive load needed score, the cognitive load of the healthcare provider team score, the cognitive load of the fungible resources team score, and the average task at risk value to calculate the task at risk opportunity score.

13. The system of claim 11, wherein the PIC module:
identifies high value tasks from the one or more tasks to perform to treat the patient;
identifies tasks that are at risk of failure from the one or more tasks to perform to treat the patient; and
determines as tasks at risk those tasks identified both as high value and as at risk of failure.

14. The system of claim 11, wherein the PIC module derives the task at risk opportunity score to minimize both false positives and false negatives.

15. The system of claim 11, wherein the PIC module determines high value patients and only analyzes the determined high value patients.

16. The system of claim 11, wherein the tipping point module determines that a healthcare provider in the healthcare provider team has reached cognitive overload; and the PIC module performs one of:
double checking double of a task at risk of the healthcare provider experiencing overload;
offloading a task at risk from the healthcare provider experiencing overload to a flexible resource in the flexible resource team; and
delaying performance of a task at risk that the healthcare provider experiencing overload was supposed to perform.

17. The system of claim 11, wherein the notification module notifies at least one healthcare provider in the healthcare provider team of a change in tasks at risk to perform.

18. The system of claim 17, wherein the PIC module prepares a daily action plan listing tasks to be performed by a healthcare provider; and the notification module distributes the daily action plan to at least one healthcare provider in the healthcare provider team.

19. The system of claim 11, further comprising:
determining if the total tasks at risk score exceeds a threshold; and
allocating the tasks at risk for the patient when the total tasks at risk score exceeds the threshold.

20. The system of claim 1, wherein the determined cognitive load needed score, the cognitive load of the healthcare provider team score, the cognitive load of the fungible resources team score, and the average task at risk value are stored in a task at risk scoring model.
